(19) United States
(12) Patent Application Publication
(10) Pub. No.: US 2011/0066562 A1
(43) Pub. Date: Mar. 17, 2011

(54) Embedded module for real time risk analysis and treatment

(76) Inventors: Susan Stapleton, St. Louis, MO (US); Srinivasa Kakkera, Newark, CA (US)

(21) Appl. No.: 11/919,926

(22) PCT Filed: May 22, 2006
(86) PCT No.: PCT/US2006/019862

§ 371 Date: Mar. 12, 2009

Related U.S. Application Data
(60) Provisional application No. 60/683,928, filed on May 23, 2005.

(51) Int. Cl. G06Q 10/00; G08B 23/00

(52) U.S. Cl. 705/317; 705/1.1; 340/573.1

(57) ABSTRACT

A computer-based business application (CBBA) management system includes multiple real time agents (RTAs) embedded with local CBBA software in order to permit cross-application functions and/or real-time functions such as local monitoring, reporting, or prevention.

### BACKGROUND

1. Field of the Invention

The present invention relates to computer systems that perform computer based business application (CBBA) functions. More particularly, the invention concerns a CBBA management system where multiple real time agents (RTAs) are embedded with local CBBA software in order to permit cross-application functions and/or real-time local monitoring, reporting, and prevention.

2. Description of the Related Art

Enterprise resource planning (ERP) systems are management information systems that integrate, automate, track, and regulate many business practices of a company. ERP systems can address many facets of a company's operation, such as accounting, sales, invoicing, manufacturing, logistics, distribution, inventory management, production, shipping, quality control, information technology, and human resources management. ERP systems can include computer security to protect against outside crime such as industrial espionage, and to protect against inside crime such as embezzlement. ERP systems can be set up to detect, prevent, and report a variety of different occurrences of fraud, error, or abuse. ERP systems can be oriented to the company's interactions with customers (“front end” activities), quality control and other internal workings of the company (“back end” activities), interactions with suppliers and transportation providers (“supply chain”), or other aspects of business.

It is becoming increasingly beneficial for companies to supplement ERP systems with compliance control applications in view of recent laws such as “The Sarbanes-Oxley Act of 2002” (Pub. L. No. 107-204, 116 Stat. 745, Jul. 30, 2002), also known as “Sarbanes-Oxley” or the “Public Company Accounting Reform and Investor Protection Act of 2002” or “SOX.” Sarbanes-Oxley seeks to protect investors by improving the accuracy and reliability of corporate disclosures. The act covers issues such as establishing a public company accounting oversight board, auditor independence, corporate responsibility, and enhanced financial disclosure. Among other things, Sarbanes-Oxley requires CEOs and CFOs to certify financial reports. Moreover, Sarbanes-Oxley mandates a set of internal procedures designed to ensure accurate financial disclosure.

Although modern ERP systems help companies become better organized and some even address the challenges of regulatory requirements such as Sarbanes-Oxley, operating, administering, or modifying an ERP system can be exceedingly complex. Indeed, because of their wide scope of application within a company, ERP software systems rely on some of the largest bodies of software ever written. Some particular problems are highlighted as follows.

First, conventional ERP monitoring solutions assess risk “after-the-fact” through the use of detection solutions that operate on downloaded data. For a large enterprise, downloading can take hours. By the time the download and analysis are complete, new users, new role assignments, and new transactions have already altered the system. Any corrective work may fail to eliminate the conflict, since it would be executed on an already-changed system. And, whether the corrective work succeeded would not be known until another download and analysis can be completed. There is significant potential for cascading negative effects.

Moreover, since constant downloading depletes information technology (IT) and system resources, few advocates of after-the-fact monitoring execute a controls analysis more frequently than daily or weekly. Depending on the frequency of downloading and analysis, violations could persist for a considerable length of time before being discovered. By the time risk is assessed in this manner, the damage might already be done. In this respect, some conventional solutions expend considerable computing resources to assess risk, yet still are not fast enough.

Second, the market is packed with ERP products from a variety of vendors. Some examples include SAP R/3 (or mySAP ERP) from SAP, PeopleSoft (or Oracle Financials) of Oracle Corporation, BPCS from SSA Global Technologies, Enterprise Business System from Made2Manage Systems, NetERP from NetSuite Inc., Microsoft Dynamics from Microsoft Business Division, Ramco e.Applications from Ramco Systems, SYSPRO ERP software from SYSPRO, and more. In some or all cases, these products are not compatible with each other. Still, a single company could conceivably use ERP products of different vendors concurrently. This, however, would expose the company to inter-application risks, namely, risks that occur across the different ERP systems. None of the individual ERP systems is capable of detecting these inter-application risks.

Third, even though companies may utilize an ERP system to monitor and enforce their business process controls on an ongoing basis, there is no assurance that such ERP application is properly configured to effectively and reliably guard against fraud and errors as well as to minimize inefficiencies. Due to the complexity of ERP systems, there are cases where there are still holes in the system of risk controls, and these may be not easily uncovered. Breakdown in these controls can prove extremely costly through higher rates of fraud, significantly higher auditing costs, increased possibility of financial restatements, and diminished investor confidence.

Consequently, known ERP systems are not always adequate for all applications and users due to certain unsolved problems.

### SUMMARY

A CBBA management system includes multiple RTAs embedded with local CBBA software in order to permit cross-application functions or real-time functions such as local monitoring, reporting, or prevention.

The teachings of this disclosure may be implemented in many different ways, such as a system, method, apparatus, logic circuit, signal bearing medium, or a combination of these. This disclosure provides a number of other advantages and benefits, which should be apparent from the following description.

### BRIEF DESCRIPTION OF THE DRAWINGS

FIG. 1 is a block diagram of the hardware/software components and interconnections of a CBBA system where RTAs are embedded in local CBBA subsystems.

FIG. 2 is a block diagram of the hardware/software components and interconnections of an RTA.

FIG. 3 is a block diagram of a digital data processing machine.

FIG. 4 shows an exemplary signal-bearing medium.

FIG. 5 is a perspective view of exemplary logic circuitry.

FIG. 6 is a flowchart illustrating a sequence for operating an RTA.

FIG. 7 is a flowchart illustrating a sequence for operating a shared CBBA manager.

FIG. 8 is a flowchart illustrating a sequence for detecting, preventing, and/or reporting the creation or modification of roles that have the potential to violate company guidelines:

FIG. 9 is a flowchart illustrating a sequence for building rules to monitor activity in one or more CBBA subsystems.

FIG. 10 is a block diagram illustrating the relationship between business activities, CBBA subsystem-specific tasks, and risks.

### DETAILED DESCRIPTION

The nature, objectives, and advantages of the invention will become more apparent to those skilled in the art after considering the following detailed description in connection with the accompanying drawings.

### Hardware Components & Interconnections

### Overall Structure

Introduction

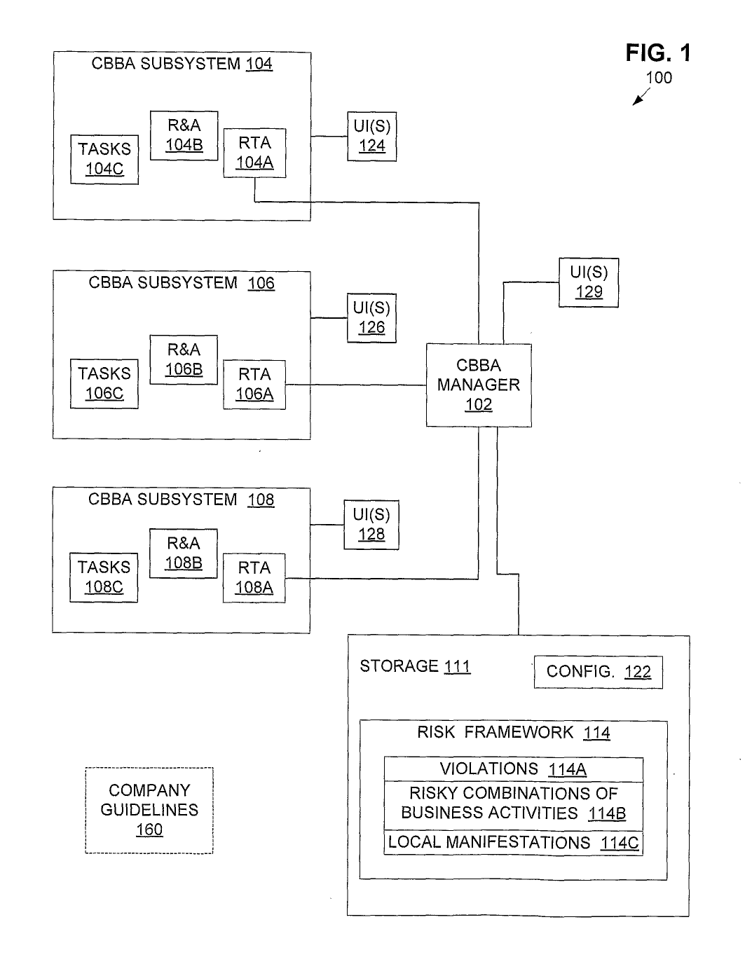

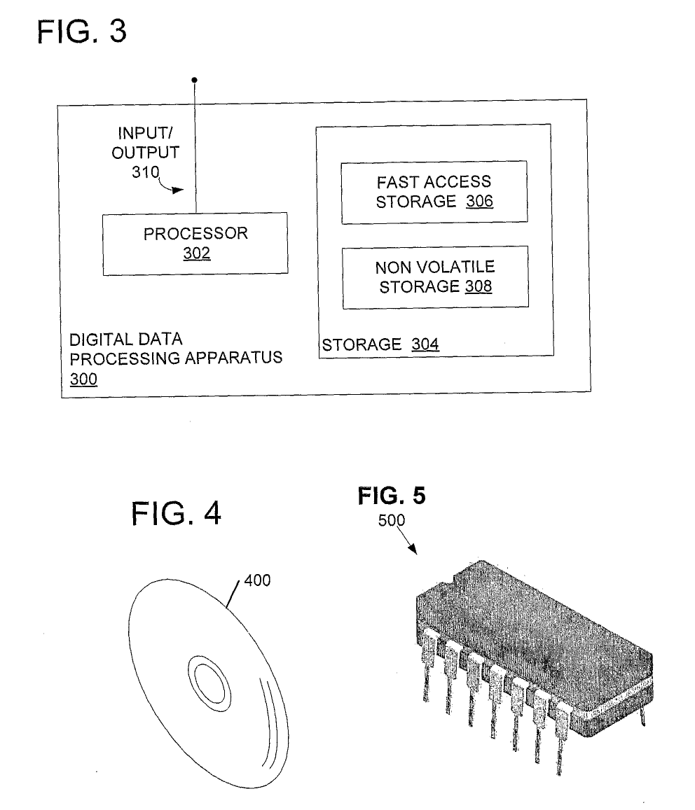

One aspect of the present disclosure concerns a CBBA system, which may be embodied by various hardware/software components and interconnections, with one example being described by the system 100 of FIG. 1. There are various data processing components of FIG. 1, such as the CBBA manager 102, local CBBA subsystems 104-106, RTAs 104a-106a, and the like. These components may be implemented by one or more hardware devices, software devices, a portion of one or more hardware or software devices, or a combination of the foregoing. The makeup of these subcomponents is described in greater detail below, with reference to FIGS. 3-5.

The components of the system 100 are operated on behalf of a client such as a company, partnership, joint venture, corporate subdivision, government unit, family, non-profit, individual, trust, or other organization or entity. In other words, data managed by the CBBA subsystems 104-106 relates to the business or other concerns of the client. The client may operate the system 100 itself, or another entity may operate the system 100 on the client's behalf.

The system 100 carries out various business activities under direction of its users, received via user interfaces such as 124-128 and 129. Another function of the system 100 is to guide, regulate, and control user activity to avoid violating various company guidelines 160. The guidelines 160 may be embodied by one or more sets of company policies, government regulations, penal law, accounting rules, good business practices, conditions imposed (for example by a charter, articles of incorporation, grant money, requirements of nonprofit status, etc.), a combination of some or all of the foregoing, or any other desired guidelines regulating activity of the entity on whose behalf the business activities of the system 100 are being conducted. Although “company” is used throughout this description, this is given in the context of a typical implementation, and should not be understood to limit the guidelines to the context of a corporation or other particular organization. These teachings are similarly applicable to any conceivable entity, certain examples of this having been given above.

For ease of explanation, the guidelines 160 are illustrated as part of the system 100. In this respect, the guidelines 160 may be stored or referenced by the system 100, and more particularly, contained in the storage 111. Nevertheless, the guidelines 160 need not constitute part of the system 100 at all, in which case they are shown and discussed for ease of description and understanding.

The system 100 includes a shared CBBA manager 102 coupled to various local CBBA systems 104, 106, 108. The manager 102 is a central module programmed to perform operations including analyzing and detecting risks occurring within individual CBBA subsystems, as well as across multiple CBBA subsystems. In a specific example, the manager 102 is implemented by a software module written in Java. Advantageously, even where the local subsystems 104-108 are incompatible with each other, the manager 102 can be used to monitor the incompatible CBBA systems for compliance with company guidelines. As described in greater detail below, the manager 102 may collect data from the RTAs 104a-108a, in order to perform various high level tasks such as risk detection, simulation, mitigation, remediation, reporting, etc.

CBBA Subsystems

In the illustrated example, the CBBA subsystems 104-108 embody different CBBA products. Advantageously, the present disclosure contemplates and addresses the situation where these CBBA subsystems are not compatible with each other. The CBBA subsystems 104-108 provide software that serves an exclusive mechanism to perform various predefined tasks on request of networked users; each subsystem also defines which of the users is permitted to perform tasks of that subsystem. As an example, CBBA subsystems may perform functions such as ERP, web server based logistics, legacy applications, physical provisioning, compliance with regulatory or other governmental regulations, or other computer based business applications.

Some examples of ERP subsystems include SAP R/3 from SAP, PeopleSoft from Oracle Corporation, Oracle Financials from Oracle Corporation, BPCS from SSA Global Technologies, Enterprise Business System from Made2Manage Systems, NetERP from NetSuite Inc., Microsoft Dynamics from Microsoft Business Division, Ramco e.Applications from Ramco Systems, SYSPRO ERP software from SYSPRO, etc. Some examples of legacy applications include file directories, mainframe computers, file servers, and other data repositories.

Coupling of the CBBA manager 102 to the subsystems 104-108 occurs via respective RTAs 104a-108a. Each RTA 104a-108a is a program module embedded into the software of its respective local CBBA host 104-108. In one example, “embedded” RTAs mean that the RTAs are integrated into the same software, firmware, logic circuitry, hardware, or other processing features of the host 104-108. In the case of a CBBA subsystem that uses an SAP software package, for example, an embedded RTA may be written in the proprietary SAP native language such as Advanced Business Application Programming (ABAP). Further, functions of an RTA in an SAP subsystem may be directly connected to SAP transactions such as Su01, SU10, profile generator (PFCG), user authorization transactions, and the like. The structure and operation of the RTAs are discussed in greater detail below.

The subsystems 104-108 are coupled to respective user interfaces 124-128. The user interfaces 124-128 comprise any device or tool for users to enter input into the local units, and receive output therefrom. The manager 102 is also coupled to one or more user interfaces such as 129. Exemplary user interfaces may employ some or all of the following: a mouse, keyboard, video display, touch screen, or any other device, tool, or software module to perform the functions required by this disclosure.

Each of the CBBA subsystems 104-108 includes a statement of local business tasks (104c-108c). The tasks are stated in a language, syntax, or other format proprietary to the host CBBA subsystems 104-106. The tasks 104c-108c serve to carry out business activities of the CBBA subsystems 104-106. In the case of a CBBA subsystem that is implemented by an ERP system, some examples of the business activities carried out by the tasks 104c-108c include creating an invoice, paying an invoice, creating an invoice, updating vendor information. In most cases, these business activities are related to the automation of business processes from beginning to end. Some examples include procurement to payment, orders to cash, production processing, and human resource benefit payment and processing. In the case of a CBBA subsystem implemented by a legacy file server, the business activities concern file operations such as reading data, deleting data, writing data, and other disk or storage management operations.

Each CBBA subsystem 104-108 also includes a statement of roles and assignments, such as 104b-106b. Broadly, the roles and assignments specify which people can perform which of the tasks 104c-108c. A role is a collection of tasks that a person or job title is permitted to perform. There may also be composite roles, which are groups of single roles. Thus, the roles outline different collections of tasks in the respective subsystem 104-108, and the assignments indicate which people are assigned to which roles. The assignments may connect people to roles directly, or they may connect job titles to roles and, independent of that, connect people to job titles. Accordingly, one function of the roles/assignments 104b-108b is to indicate the necessary permission that a requesting user must have in order for the corresponding CBBA subsystem to perform the requested task 104c-108c.

In the case of an ERP implementation of a subsystem 104-108, roles and assignments 104b-108c may (for example) prescribe that a given person can perform create invoices. In the case of a legacy implementation of a subsystem 104-108, roles and assignments may (for example) prescribe peoples' IT access rights to system resources, as with a data repository shared by network users.

Storage

The manager 102 includes or has access to digital data storage 111, such as one or more servers, hard drives, personal computers, mainframe computers, optical disks, or any other digital data storage devices appropriate to suit the needs of this disclosure. The storage includes subcomponents 114, 122 in this example. These subcomponents may be implemented by the same or different physical devices, logical devices, storage sectors or other regions, register, pages, linked list, relational databases, or other storage unit without limitation. Operation and use of the subcomponents of the storage 111 are described in greater detail below. The following is a brief description.

The configuration record 122 maintains various default settings, user-selectable options, and the like, used to set or change the functionality of the CBBA manager 102. In other words, the configuration 122 provides a record of various options as to how the CBBA manager 102 operates. Configuration 122 may include some settings set by (1) request of local users of CBBA subsystems 104-108, (2) a system level user (e.g., via user interface 129), (3) default, (4) a combination of these, (5) another mechanism. The configuration 122 therefore provides a record of default and/or optioned settings for virtually any aspect of the operation of the CBBA manager 102 as such operation is described throughout the present disclosure.

Broadly, the risk framework 114 defines activities and conditions that, if one or more CBBA subsystems 104-108 are configured to permit these, a door will have been opened for someone to commit a violation of company guidelines 160. One component of the framework 114 is a module 114a that outlines all conceivable violations of the applicable company guidelines (described above) that are capable of being perpetrated using the system 100. Relatedly, the module 114b outlines combinations of business activities that, if entrusted to a single person, would give that person the potential to perpetrate one of the violations 114a.

In one example, the definition of combinations 114b of business activities containing the potential to cause violations 114a employs includes segregation of duties as a primary internal control intended to prevent, or decrease the risk of errors or irregularities. This is achieved by assuring that no single individual has control over all phases of a business transaction. In one example, there are four general categories of duties: authorization, custody, record keeping, and reconciliation. In an ideal system, different employees perform each of these four major functions. In other words, no employee has control of two or more of these responsibilities. The more negotiable the asset, the greater the need for proper segregation of duties, especially when dealing with cash, negotiable checks, and inventories.

There are business areas where segregation of duties is extremely important. Cash handling is an example, because cash is a highly liquid asset. This means it is easy to take money and spend it without leaving a trail of where it went. Any department that accepts funds, has access to accounting records, or has control over any type of asset should be concerned with segregation of duties. Some examples of incompatible duties include:
authorizing a transaction, receiving and maintaining custody of the asset that resulted form the transaction.
receiving checks (payment on account) and approving write-offs.
depositing cash and reconciling bank statements.
approving time cards and having custody of pay checks.

For each risky combination 114b of generic business activities, the framework 114 sets forth local manifestations 114c of that risk. Particularly, for a given combination of risky business activities 114b, the module 114c identifies all the different CBBA subsystem specific tasks 104c-108c that could be used to carry out these combinations. In this regard, the module 114c may identify subsystem tasks 104c-108c by particular codes, entries, configurations, combinations, or other details compatible with the local CBBA language of that subsystem. The local manifestations 114c may include different subparts (not separately shown) individually applicable to the different subsystems 104-108. For example, one subpart may contain local manifestations particular to an SAP system, another subpart containing local manifestations particular to an Oracle system, etc.

In one example, the risk framework 114 may be implemented entirely by the local manifestations 114c, omitting the violations 114a and combinations 114b. In this case, the modules 114a-114b are shown in the storage 111 merely for purposes of illustration and explanation of the concepts behind the risk framework 114.

In the example where one of the subsystems 104-108 is implemented by an SAP ERP system, the local manifestations 114c may be implemented using the substantial library of segregation of duties rules from the Compliance Calibrator version 5.0 software of Virsa Systems, Inc. Along these lines, Table 1 (below) provides additional detail by showing an exemplary listing of violations 114a and local manifestations 114c (in functional language, rather than local syntax, for ease of reading).

TABLE 1

| | FUNCTIONAL DESCRIPTION OF | |
|---|---|---|
| | LOCAL MANIFESTATIONS | POTENTIAL VIOLATION |
| P2P PROCESS | (114C) | (114A) |
| Vendor Payments | Overpayments that would not be | Payment for goods or services |
| | discovered by the standard duplicate | not received |
| | SAP payment check. | |
| Vendor | Overpayments that would not be | Payment for goods or |
| Payments | discovered by the standard duplicate | services not received |
| | SAP payment check by looking | |
| | across organizational boundaries. | |
| Vendor | Duplicate payments of invoices. | Overstatement of Expenses |
| Payments | | |
| Invoice | Invalid manual entries completed | Misrepresentation of |
| Verification | outside the system process. | inventory statement |
| Invoice | Invalid entries to organizations | Misrepresentation of |
| Verification | | inventory statement at |
| | | company level |
| Inventory | Material valuation changes that | Misrepresentation of Stock |
| Valuation | appear out of line with standard cost | valuation |
| | tolerances or percentages. | |
| Inventory | Material valuation changes that | Misrepresentation of Stock |
| Valuation | appear out of line with moving | valuation |
| | average price tolerances or | |
| | percentages. | |
| External | Purchase or acquisition documents | Bypass policies and order |
| Procurement | that may be used to bypass | value limits and make |
| | acquisition approval procedures and | unauthorized acquisitions |
| | policies. | |
| External | Purchase transactions that are being | Bypass policies and order |
| Procurement | processed outside an approved | value limits and make |
| | release approval procedure. | unauthorized acquisitions |
| External | Purchase documents processed | Exploit procurement |
| Procurement | outside an approved release | process weakness for |
| | approval procedure. | unauthorized procurement |
| | | of goods and services |
| External | Purchase documents processed | Unauthorized procurement |
| Procurement | outside an approved release | of goods and services |
| | approval procedure. | |
| Receive Goods | Invoices in process which are | Payment for goods or |
| | bypassing the goods receipt | services not received |
| | requirement. | |
| Vendor | Vendors excluded from SAP | Potential Vendor Level |
| Payments | duplicate payment checking. | System Bypass resulting in |
| | | intentional/accidental |
| | | duplicate vendor payments |
| Vendor | Invoices in process which are | Payment for goods or |
| Payments | bypassing the duplicate payment | services not received and |
| | checks in SAP. | inaccurate posting of |
| | | expenses to an entity or |
| | | organization |
| Receive Goods | Orders that are created after goods | Unauthorized procurement |
| | are received to bypass SAP | and payment of goods and |
| | procurement controls. | services |
| Manage | Inventory adjustments made outside | Unauthorized inventory |
| Inventory | established limits | adjustment posting; |
| | | Misrepresentation of |
| | | Inventory statements, |
| | | Misappropriation of stocks |

### RTA Layout

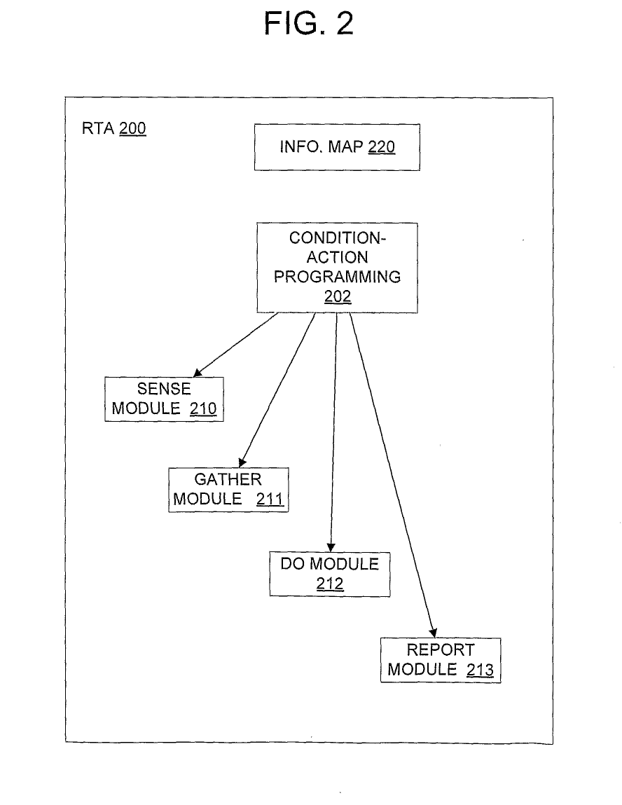

Besides the overall CBBA architecture of FIG. 1, a different aspect of the present disclosure concerns the makeup of the individual RTAs 104a-108a. Each RTA may be embodied by various hardware/software components and interconnections, with one example being described by the RTA 200 of FIG. 2. In the present example, each RTA 200 comprises a software module embedded into a respective “host” CBBA subsystem 104-106.

The exemplary RTA 200 includes condition-action programming 202, various other modules 210-213, and an information map 220. As described in greater detail below, the programming 202 conducts CBBA subsystem level functions, in cooperation with the CBBA manager 102, in order to help the manager 102 identify, prevent, and report the potential for violating guidelines 160 in and across the CBBA subsystems 104-108. For ease of description, the RTA 200 is described in the context of the subsystem 104 as host.

The programming 202 together with the modules 210-213 provide a set of operating instructions for the RTA 200. Broadly, the programming 202 identifies conditions, and in response, activates one or more of the modules 210-213. The operation of the RTA 200 and its subcomponents are described in greater detail below.

Accessible by the sense, gather, do, and report modules 210-213 is the information map 220. The map 220 lists the location of various client data, configuration settings, and other information stored in the host CBBA subsystem. Data may be listed by physical or logical address, device, pointer, sector, or other useful identifier. In the example 104, the map 220 indicates the location of the roles 104b, tasks 104c, configuration data of the subsystem 104, and other client information, metadata, and configuration settings.

### Exemplary Digital Data Processing Apparatus

As mentioned above, various forms may be used to implement data processing entities such as the CBBA manager 102, subsystems 104-108, RTAs 104a-108b, etc.

Some examples include a general purpose processor, digital signal processor (DSP), application specific integrated circuit (ASIC), field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As a more specific example, FIG. 3 shows a digital data processing apparatus 300. The apparatus 300 includes a processor 302, such as a microprocessor, personal computer, workstation, controller, microcontroller, state machine, or other processing machine, coupled to digital data storage 304. In the present example, the storage 304 includes a fast-access storage 306, as well as nonvolatile storage 308. The fast-access storage 306 may be used, for example, to store the programming instructions executed by the processor 302. The storage 306 and 308 may be implemented by various devices, such as those discussed in greater detail in conjunction with FIGS. 4-5. Many alternatives are possible. For instance, one of the components 306, 308 may be eliminated; furthermore, the storage 304, 306, and/or 308 may be provided on-board the processor 302, or even provided externally to the apparatus 300.

The apparatus 300 also includes an input/output 310, such as a connector, line, bus, cable, buffer, electromagnetic link, network, modem, or other means for the processor 302 to exchange data with other hardware external to the apparatus 300.

### Signal-Bearing Media

As mentioned above, various instances of digital data storage may be used, for example, to provide storage 111 and other storage used by the system 100 (FIG. 1), to embody the storage 304 and 308 (FIG. 3), etc. Depending upon its application, this digital data storage may be used for various functions, such as storing data, machine-readable instructions, metadata, configuration settings, etc. Machine readable instructions, stored in such a storage medium, may themselves aid in carrying out various processing functions, or they may serve to install a software program upon a computer, where such software program is then executable to perform other functions related to this disclosure.

In any case, the digital data storage may be implemented by nearly any mechanism to digitally store machine-readable signals. One example is optical storage 400 (FIG. 4) such as CD-ROM, WORM, DVD, digital optical tape, or other optical storage. Another example is direct access storage, such as a conventional “hard drive”, redundant array of inexpensive disks (“RAID”), or another direct access storage device (“DASD”). Another example is serial-access storage such as magnetic or optical tape. Still other examples of digital data storage include electronic memory such as ROM, EPROM, flash PROM, EEPROM, memory registers, battery backed-up RAM, etc.

Exemplary storage media may be coupled to a processor so the processor can read information from, and write information to, the storage medium. In the alternative, the storage medium may be integral to the processor. In another example, the processor and the storage medium may reside in an ASIC or other integrated circuit.

### Logic Circuitry

In contrast to signal-bearing media that contain machine-executable instructions (as described above), a different embodiment uses logic circuitry to implement processing components of FIGS. 1-2.

Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

FIG. 5 shows an example of logic circuitry in the form of an integrated circuit 500.

### Operation

Having described the structural features of the present disclosure, the operational aspect of the disclosure will now be described. The steps of any method, process, or algorithm described in connection with the embodiments disclosed herein may be embodied directly in hardware, in a software module executed by hardware, or in a combination of the two.

### CBBA Subsystem Functions

Each of the CBBA subsystems 104-108 conducts various computer based business application operations, depending upon the particular software package of the subsystem and the client subject matter that is being managed. As to the software package, this may involve well known tasks of products such as SAP R/3 (or mySAP) from SAP, PeopleSoft or Oracle Financials from Oracle Corporation, BPCS from SSA Global Technologies, Enterprise Business System from Made2Manage Systems, NetERP from NetSuite Inc., Microsoft Dynamics from Microsoft Business Division, Ramco e.Applications from Ramco Systems, SYSPRO ERP software from SYSPRO, legacy software, or another product. As to the client subject matter, this may comprise an accounting system, accounts payable, inventory system, governmental bidding or contract compliance, regulatory compliance, human resources, quality control, or any other subject matter.

In a specific example, the CBBA subsystems 104-108 permit users to conduct various tasks 104c-108c, such as creating invoices, paying invoices, creating accounting reports, etc. However, the subsystems 104-108 limit the conditions under which the tasks 104c-108c are performed according to the roles and assignments 104b-108b. Thus, if a user of the subsystem 104 requests to perform one or more of the tasks 104c and the subsystem 104 determines that is outside the user's role 104b, the subsystem 104 prevents, terminates, or reports the performance of this task.

### RTA Operation

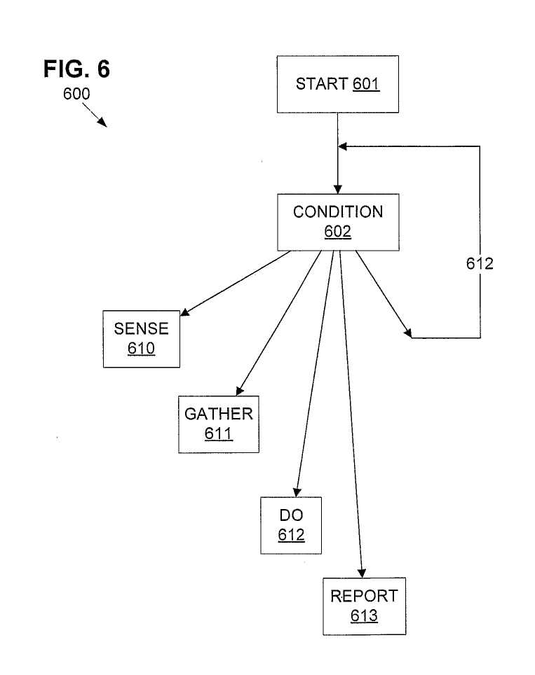

FIG. 6 shows a sequence 600 for operating an individual one of the RTAs 104a-108a, according to one example. Although the sequence 600 may be implemented in a broader context, for ease of explanation the following description is made in the specific environment of FIGS. 1-2. Specifically, the sequence 600 is described in context of the RTA 104a as implemented by the layout 200.

In step 601, the RTA 104a begins operation. Step 601 may occur, for example, when the host CBBA subsystem 104 is installed, manufactured, configured, initially booted, rebooted, etc. As a different example, the RTA may begin operations separately from the host CBBA subsystem.

In step 602, the condition-action programming 202 determines whether any of various predetermined conditions exist. Broadly, the conditions include status of the host CBBA subsystem or events occurring within it as previously determined by the sense or gather modules 210/211, communications received from the CBBA manager 102, status of execution of the modules 210-213, etc. The following describes some examples of conditions:
A condition that the RTA 104a has sensed (610) receipt of an instruction from the CBBA manager 102.
A condition that one or more of the tasks 610-613 (described below) has completed.
A condition that one or more of the tasks 610-613 has completed with a certain result. For example, a sense task 610 finding that a user has submitted a request to change a role of 104b.
A condition indicating that the RTA 104a has sensed (610) the existence of certain data, operational configuration, or other state or context of the subsystem 104 or any of its subcomponents.
Other conditions pertaining to the subsystem 104 and/or its communications with users or the CBBA manager 102.

To avoid missing the occurrence of any conditions, the check for conditions (step 602) is conducted repeatedly, as shown by 612. Step 602 may be performed periodically, on a non-periodic schedule, responsive to a timer or clock, responsive to a frequently occurring event, or other trigger.

When the condition-action programming 202 finds occurrence of a predefined condition in step 602, the programming 202 invokes one or more of the operations 610-613 according to predetermined logic of the programming 202. The tasks 610-613 are performed by respective modules 210-213, and operate according to the functionality of the modules 210-213 described above.

In step 610, the sense module 210 passively observes messages, signals, events, and other occurrences in the host subsystem 104. For example, the module 210 senses when a user requests to change a role or assignment 104b. As another example, the module 210 may sense existence of sensitive configuration parameters, such as a “sense duplicate invoices” option being turned off for a certain vendor. The module 210 may also sense critical data values, such as when a recurring entry exceeds a given threshold. As another example, the module 210 may sense when commands are received from the CBBA manager 102.

To perform step 610 with sufficient frequency, the relevant condition (602) may be arrival of a recurring alarm, schedule, etc. Depending upon the condition-action programming 202, different results of step 610 create may create different conditions, which (when step 602 is performed again) trigger the performance of other tasks 610-613. For instance, step 610 may sense a user request to create a role, which constitutes a condition (602) resulting in reporting (613) of this situation to the CBBA manager 102.

In step 611, responsive to the appropriate condition (602), the gather module 211 actively obtains information about activity in the host CBBA subsystem. For example, the gather module 211 may retrieve information from the host subsystem 104's roles and assignments (104b), tasks 104c, other data the subsystem 104, default or user configuration of the subsystem 104, etc. As further examples of the operations 611 of gather module 211, these may seek to collect information supporting any of the controls from Table 1, described above. In performing task 611, the gather module 211 makes use of the map 220. For instance, in response to a general request for information (step 602), the module 211 in step 611 may consult the map 220 to identify specific storage locations in the host CBBA subsystem 104 where such data is located.

With step 611, some examples of a preceding condition (602) include a direct command from the CBBA manager 102, or the completion of any of the tasks 610-613, a particular result of the tasks 611-613, etc. Depending upon the condition-action programming 202, different results of step 611 create may create different conditions, which when step 602 is performed again, trigger the performance of other tasks 611-613. For instance, the completion of task 611 may trigger (step 602) reporting 613 of the results to the CBBA manager 102, or performance of a follow up action (612).

In step 612, the do module 212 performs affirmative acts of the RTA 200. As one example, the do module 212 may prevent a change in roles and assignments (104b), prevent assignment of a role to a user, etc. As another example, the module 212 may create a “case”, assign a case number, fill-out the case with various information obtained from the sense and gather module 210, 211. In the case of step 612, the condition (602) may specify that the do module 212 operate responsive to a request, trigger, or other act initiated by the CBBA manager 102, or responsive to the completion or result of another of the tasks 610-613.

In step 613, the report module 213 prescribes operations of sending messages, files, data compilations, alerts, or other reports to the CBBA manager 102. Step 613 operates in response to conditions (602) such as command from the CBBA manager 102, or responsive to completion or result of a previous one of tasks 610-613.

With the modules 210-213 at its disposal, the programming 202 may orchestrate complicated operations by combining the tasks 610-613 in various combinations, with various conditions (602) precedent. Some examples include composite operations such as sense and do, sense and report, gather and do and report, etc. For instance, responsive to the sense module 210 detecting (610) that a user has requested a role change, the programming 202 may direct module 211 to gather (611) information about the user, and then direct module 213 send (613) a report of the collected information to the CBBA manager 102.

### System Functions Including Cross-Application Analysis

Introduction

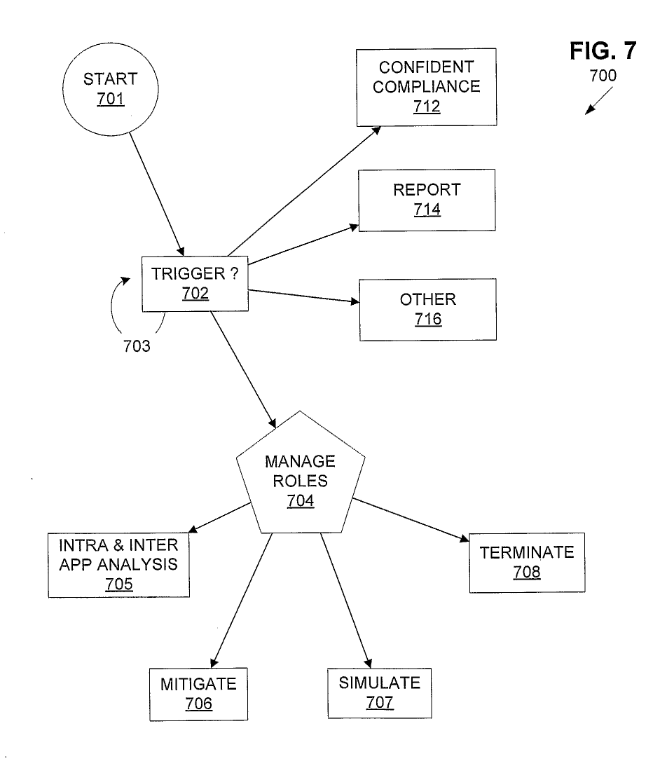

FIG. 7 shows a sequence 700 for performing various system functions including operations occurring across several incompatible CBBA subsystems, according to one example of the method aspect of this disclosure. Although the sequence 700 may be implemented in a broader context, for ease of explanation the following description is made in the specific environment of FIGS. 1-2. More particularly, the sequence 700 is described in reference to the CBBA manager 102.

Broadly, in step 701 the CBBA manager 102 begins managing the system 100. Step 701 may commence upon installation of the CBBA manager 102, configuration, reconfiguration, boot up, addition of another RTA, upgrade of a system 100 component such as the manager 102, etc.

After the CBBA manager 102 starts (701), the manager 102 asks (702) whether one of various triggers has occurred. Each trigger 702 is one of various predefined tasks, events, conditions, or other occurrences. Some examples of triggers include arrival of a given message from one of the RTAs 104a-108a, arrival of a predetermined time, expiration of a counter, detection of a condition of the potential for a violation of guidelines 160 occurring on the CBBA subsystems, etc. Instances of different triggers are described in greater detail below.

Occurrence of a trigger (702) leads the CBBA manager 102 to perform one of the tasks 704, 712, 714, 716. In any case, the check for a trigger (702) is performed on a repeating basis (703) to avoid missing any new triggers that occur, regardless of whether one of the processes 704, 712, 714, 716 is already underway due to a previous trigger.

Manage Roles: Introduction

In step 704, the CBBA manager 104 assists CBBA subsystem users in creating, modifying, redefining and modifying roles 104b-108b. The trigger 702 for the operation 704 occurs when a local RTA sends a report (step 613, FIG. 6) to the CBBA manager 102 that a user has requested to add a new role or modify an existing role. In this disclosure, such a request is referred to as a “role change” request. Responsive to detecting the role change request (702), in step 704 the CBBA manager 102 receives, analyzes, and processes the user's role change request.

In one example, step 704 may employ the ROLE EXPERT version 4.0 software product of Virsa Systems, Inc. During step 704, the CBBA manager 102 employs the applicable RTA to provide a substantially real-time interface to the user and host CBBA subsystem. Some exemplary operations of the role management task (704) include the following:
showing multiple roles and their common relationship to a job or position, regardless of subsystem boundaries.
defining and maintaining role definitions.
defining and maintaining tasks.
comparing roles and role definitions.
displaying user information.
reviewing objects assigned to a role.
defining a composite role.

In addition to these, step 704 may facilitate a number of reports and utilities, with the following serving as some examples:
generating role reports.
checking TCodes in menu and authorizations.
comparing users' roles.
listing roles assigned to a user.
listing roles and transactions.
checking role status.
creating or modifying derived roles.
counting authorizations for roles or users.
analyzing owners, roles, and users.
identifying transactions executed by users or roles.

Optionally, role management 704 may be applied with various enhanced functions related to role creation. When roles are created they may be created to cover generic positions or activities related to jobs. Many people in the organization may be able to complete the same activities but are limited to only those activities associated with one entity or location. This means that the capabilities remain the same but the location or entity may vary. So an Accounts Payable Clerk may exist in hundreds of company plants, in which case, the only variation of the role is what plant. Once the alternative values for the plant are specified, the RTA generates all the variations by inserting the organizational limitations into the roles. Thousands of roles can also be maintained by using the RTA to find all roles with common elements that need to be changed. For example reorganizations or mergers may cause certain role contents to vary. The RTA will display the roles affected and allow the user to change all roles with unique values as opposed to using the conventional one by one method provided by the native system tools.

In addition to the foregoing functions, step 704 may facilitate various risk reports, which employ the risk analysis of step 705, as discussed below. Risk reports, requested by users of the subsystems 104-106, may include reports presenting risks or conflicts, the occurrence of critical transactions by user or role or profile or HR object, etc.

The process 700 includes a number of peripheral tasks related to step 704. Namely, once the CBBA manager 102 has embarked on the role management process 704, the CBBA manager 102 offers other related processes to the user. In addition to directing the user toward the tasks 705-708, task 704 may coordinate use of the different tasks 705-708 to implement an intelligent and systematic approach to performing various user operations. For example, after a requested role change request is found to violate the risk framework 114 (as learned in task 705, described below), task 704 may permit an approver to de-select roles one-by-one and then to simulate (task 707, described below) the effects of that modified profile. This allows the approver to check whether the proposed role(s) continue to pose segregation of duties violations, and at what point they stop. In this way, the approver can also isolate which specific role or combination of roles is the cause of the segregation of duties violations. In another example, step 704 ensures that sensitive access is not introduced without management acknowledging its presence, and ensures that sensitive access is approved before roles are made available for use. In another example, the operation 704 may provide an emergency “fire fighter” function to track activities of personnel when utilizing sensitive roles.

Optionally, the operation 704 may also include a computer-assisted remediation function, whereby the CBBA manager 102 assists a CBBA subsystem user (such as a role approver) in treating risks found in the analysis of step 705. In remediation, the CBBA manager 102 coordinates options such as removing a requested or proposed role addition or change that caused a risk violation found in step 705, or commencing mitigation 706, etc. After completing the selected one of these options, the resulting role change more closely satisfies the guidelines 160. Furthermore, remediation may include timely reporting and documentation of the actions taken to investigate the risk, and also provide evidence that management is actively managing risk and/or complying with regulations. In the case of process controls, the reporting of risky conditions may be based on a transaction exceeding a “tolerance” level in the rule. An example is payment terms are usually thirty days, however, on one transaction they are changed to sixty. Notification to a responsible person will allow them to evaluate the circumstances associated with the exception and either change it back or document the circumstances and justification for the variance. This is prevalent for special one-time transactions that are created outside the normal course of business that need to be reviewed to make sure financial reporting restrictions or regulations are not violated.

Some detailed examples of the task 705-708 are described as follows.

Running Risk Analysis

In step 705, the CBBA manager 102 analyzes each requested role change (from 704) to determine whether it would violate the risk framework 114. For example, in the case of the CBBA subsystem 104, the CBBA manager 102 analyzes role change requests to determine whether the proposed role change, if implemented in 104b, would violate the risk framework 114. For ease of discussion, role “changes” are understood to include role modifications as well as role additions.

Step 705 may be performed upon request of a user or approver, or automatically whenever a user submits a role change request to a subsystem. In step 705, the CBBA manager 102 invokes the appropriate RTA to gather from the subsystem 104 (and report back) all related information concerning the role change request, including content of the request, information about the subject role, etc. The required information may be prescribed, for example, by the risk framework 114. With this information, the manager 102 then compares the gathered informtion to the local manifestations 114c to see if there is a match. If the gathered information matches the local manifestation 114c appropriate to the relevant host subsystem 104-108, the role change as proposed contains the potential to violate the company guidelines 160.

Advantageously, due to the CBBA manager 102's position to centrally supervise role management across all subsystems 104-108, the manager 102 can also conduct cross-application analysis to detect risk (i.e., the potential for violations of the guidelines 160) occurring across multiple CBBA subsystems, even though no risk may be present within one CBBA subsystem or another. In this respect, step 705 considers a given role change request by directing the RTAs 104a-108a to collect all related information from the respective subsystems 104-108, bundling this data and analyzing the bundled data as a whole against the body of local manifestations 114c.

Thus, the CBBA manager 102 can detect issues across the subsystems 104-108. In one example, the CBBA manager 102 goes to each subsystem and looks for a “user id” in that system, and it detects then gathers technical information for comparison to the risky combinations in the rules framework. When there are matches, the source data gathered is able to track which ones belong to which systems. For example, if a user can update a vendor in one subsystem and make a payment in another subsystem, the CBBA manager 102 will discover both and then report from which role in which system the match was found.

In this manner, then, the CBBA manager 102 can detect any of the risks (114a) occurring across multiple CBBA subsystems. As a further advantage, information required to conduct the analysis of step 705 is obtained substantially in real time using the RTAs 104a-108a, rather than having to wait for time consuming downloads of information from CBBA subsystems 104-108.

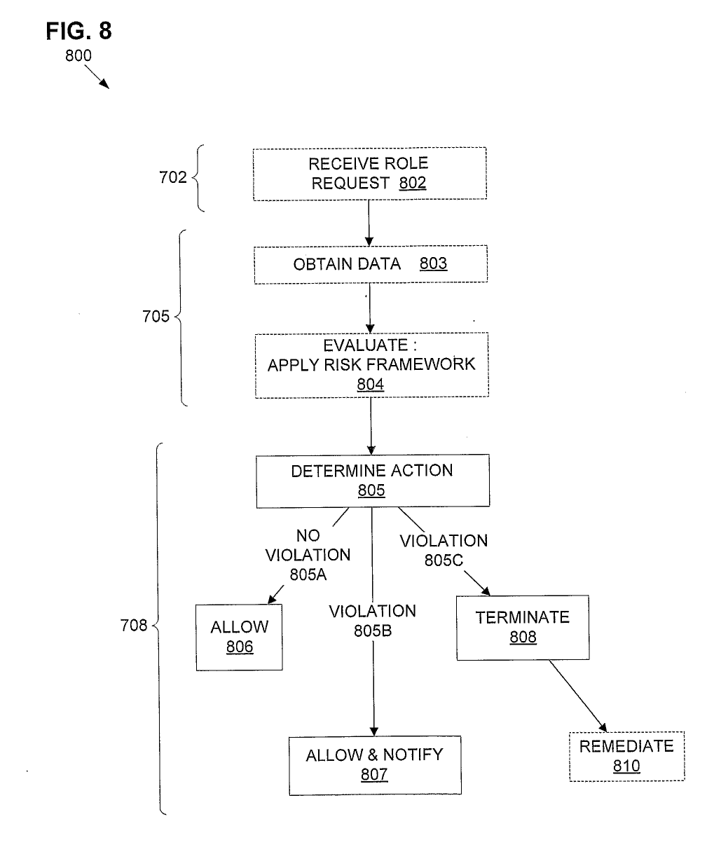

Step 705 is illustrated in greater detail below, in the description of the sequence 800 (FIG. 8). In one example, the step 705 employs features of Virsa Systems, Inc. software products such as COMPLIANCE CALIBRATOR version 5.0 and/or CONFIDENT COMPLIANCE version 1.2.

Mitigation

In step 706, the CBBA manager 102 performs risk mitigation. In one example, this operation is triggered automatically whenever the CBBA manager 102 detects (in step 705) that a user's proposed role change would violate the risk framework 114.

Mitigation is an action to address a violation of the risk framework 114. A mitigation control exempts or overrides an identified risk or prospective audit exception, permitting it to occur even though it violates the risk framework 114. Having selected a specific risk framework 114 violation, the approver can override the violation with a management approval that is captured in the system to maintain an audit trail. Some examples of mitigation controls include limiting existence of a new or changed role to a given time period (i.e., planned expiration of the role), automatically generating reports on activity concerning the role, etc.

Another example is useful in a small office, where many of the risky combinations must performed by one person because it is not possible to segregate the risky tasks. Here, one exemplary mitigation operation 706 offered by the CBBA manager 102 is to program the RTAs 104a-108a to alert the CBBA manager 102 when this person executes these risky combinations. In turn, the CBBA manager 102 prompts the person's supervisor to ask for transaction supporting documentation to ensure the occurrence is legitimate. In another example, the manager 102 and RTAs cooperatively generate a detail report of changes which can be reviewed by a supervisor (or other person whose role includes the risky combination) on a routine basis and compared to supporting documentation. In another example, the CBBA manager 102 and RTAs only allow the risky combinations to be approved for a limited period of time, for example while the designee is assuming tasks for another person who is the other half of the risky combination. In this case the CBBA manager 102 and RTAs may be programmed to alert the person when the limited period is up, and automatically remove his/her access.

In addition, the mitigation procedure 706 may be configured to notify a “supervisor” or third person of an event, in order to begin remediation actions. Because this is system intelligence gathered, the decision can be made to notify a person specified in the control in one location as opposed to another based on who has executed the combinations independent of the system location. This enables one common mitigating control to be utilized to control risks the same way but notify different individuals to execute based on the person who is found to have actually executed the combination. In another example, in mitigation 706 the CBBA manager 102 issues a command to record the mitigating control for the current user to manage the risk detected with a pre-approved alternative control. In one example, implementation of the mitigation operation 704 employs features of the COMPLIANCE CALIBRATOR software product of Virsa Systems, Inc.

As described above, the procedure 706 benefits from the RTA architecture in numerous ways, such as by obtaining substantially real-time access to data in the subsystems 104-108. Moreover, the RTAs can be used to report incidents that take place when two risky combinations actually take place, as opposed to reporting that such a combination is theoretically possible. The real-time aspects enable the system 100 to provide an embedded remediation solution for those risky combinations that must exist because of certain business limitations discussed above. Another advantage is that, upon creating an exception for an individual to have the risky access, there is a monitoring mechanism in place immediately to report incidents of their execution on a real-time basis as they occur.

Simulation

In step 707, the CBBA manager 102 performs simulation. In one example, this operation is triggered automatically when the CBBA manager 102 detects (in step 705) that a user's proposed role would violate the risk framework 114. As another option, the user may initiate step 707 manually by request.

In simulation 707, the supervisor, manager, or other role approver proposes various hypotheticals, and the CBBA manager 102 determines whether this would violate the risk framework 114. For example, the hypotheticals may specify the details of a given role addition, role modification, role assignment, mitigating condition, etc. Advantageously, like the cross-application analysis of step 705, the simulation of step 707 may similarly perform bundling and other techniques to perform cross-application analysis of risk involved in the hypothetical situation. In one example, implementation of the simulation operation 707 employs features of the CONFIDENT COMPLIANCE and COMPLIANCE CALIBRATOR software products of Virsa Systems, Inc.

The procedure 707 benefits from the RTA architecture described above, for example, by obtaining substantially real-time access to data in the subsystems 104-108, therefore providing an up-to-date and extremely accurate simulation.

Risk Termination

In step 708, the CBBA manager 102 performs a risk termination process. In particular, when a user-proposed role change or addition violates the risk framework 104 (step 705), then step 708 either (1) allows the role change despite the risk, but notifies someone about the role change, or (2) prevents the role change from being consummated. The specific actions of step 708 are discussed in greater detail below with reference to the sequence 800 (FIG. 8). In one example, step 708 may employ the COMPLIANCE CALIBRATOR software product of Virsa Systems, Inc.

Confident Compliance

As mentioned above, the role management operation 704 and its sub-processes 705-708 help ensure that the roles 104b-108b of any one CBBA subsystem 104-106 do not violate the risk framework 114, and that the roles 104b-108b do not present any cross-platform risk exposure. Nevertheless, it is still conceivable that roles could be defined in some situations that still present the potential for violating the guidelines 160. For example, due to mitigation controls (706), some otherwise prohibited transaction combinations are allowed, but it is desirable to have management monitor such transactions to make sure they never exceed a given tolerance. Another example is where roles containing many capabilities have to be allowed for emergency situations. In these cases the roles would be constructed with violations; however, there would be a mitigating control surrounding the approval of these roles for assignment to individuals for emergencies only.

The confident compliance process 712 addresses these and other such possibilities. Broadly, in the confident compliance operation 712, the CBBA manager 102 monitors the subsystems 104-108 for prescribed conditions. Based upon the results of this review, the CBBA manager 102 then issues one or more reports, and may further initiate designated follow up action by designees. The procedure 712 benefits from the RTA architecture described above, by obtaining substantially real-time access to data in the subsystems 104-108.

Initially, the trigger (702) for confident compliance 712 is invocation of the process by an authenticated user, such as a qualified manager. At this time, the user-manager interacts with the CBBA manager 102 to define conditions to be monitored in the subsystems 104-108. Namely, the user specifies items to be monitored, such as desired tasks 104c-108c, roles and assignments 104b-108b, master data (e.g. customers and vendors), subsystem configuration options, changes to system configuration options, etc. The user may also specify actions to be taken whenever these conditions occur, such: (1) generating reports, and the format, content, and recipients of such reports, (2) preparing a log or other audit trail to be created, (3) invoking human workflow whenever certain conditions occur, such as starting role management (704) or mitigation (706) or another process, etc., and/or (4) working with native software of the subsystems 104-108 to stop or prevent certain actions from occurring.

After this initial setup, confident compliance 712 is re-triggered (702) when any of the specified conditions occur. Namely, the RTAs 104a-108a (as programmed by the CBBA manager 102) detect the given conditions and report their occurrence to the CBBA manager 102, whereupon the CBBA manager 102 takes the pre-specified actions, such as generating a report, preparing a log, invoking human workflow, etc.

In addition to the user-specified conditions, confident compliance 712 may monitor the subsystem 104-108 for occurrence of default or system-specified conditions, such as known weak points, typically troublesome areas, deficiencies that have especially severe consequences, etc. Responsive to these conditions, the process 712 may perform similar follow up actions as in the case of user-specified conditions, e.g., generating a report, preparing a log, invoking human workflow, stopping action from occurring, etc.

As a further example, upon detecting specified tolerance or conditions, an RTA may generate a remediation case and workflow it to a designated person or group via the CBBA manager 102. The CBBA manager 102 then documents the case as to the actions or justifications for the exception. Here the remediation is initiated and tracked within confident compliance 712 to make sure the exception is either corrected or adequately justified before the case is closed.

As another example, if an administrator initiates a configuration change to stop the detection of duplication payments in one of the subsystems 104-108 (in violation of company guidelines 160), the relevant RTA 104a-108b detects this, reports it to the CBBA manager 102, and automatically acts to prevent the change before being implemented in the local subsystem.

According to one aspect, then, confident compliance 712 is useful to pinpoint bottlenecks and chokepoints in business processes by setting tolerances and thresholds for processes to be monitored on a real-time, continuous basis. Confident compliance 712 may, for example, monitor prescribed hot spots & holes in the CBBA monitoring mechanism, and also to observe additional, management-specified criteria. The operation 712 also increases visibility into control effectiveness by monitoring master data, configuration, and transactions in key business processes. Optionally, the operation 712 may provide role-based dashboards to give managers and auditors instantaneous access to the control deficiencies. Confident compliance 712 may be implemented to provide further include features such as (1) built in master controls for procure to pay, order to cash, finance, (2) automated and consistent testing, (3) integration with control repository, (3) pinpointing of exceptions and related transactions and docs, (4) remediation workflow and tracking, and (5) others.

Reporting

In step 714, the CBBA manager 102 provides one or more output reports. This may involve reporting on the status, configuration, transaction history, usage, current tasks 104c-108c and/or roles and assignments 104b-108b, or other properties of the CBBA subsystems 104-108 or their subcomponents, or the risk framework 114, configuration 122, etc. The reports 716 may be generated on-demand, or automatically in response to designated reporting criteria. Advantageously, reporting 716 benefits from the RTA architecture described above, by obtaining substantially real-time access to data in the subsystems 104-108.

Other

In addition to those operations 712-714 specifically addressed above, the CBBA manager 102 may be expanded or modified to perform numerous tasks 716 within the given environment 100.

### Risk Terminator

As mentioned above, the CBBA manager 102 receives and processes users' requests to add and change roles over time (in step 704), and thereby build, refine, revise, and update role collections 104b-106b over time. FIG. 8 shows a sequence 800 providing a linked example of the triggering (702), analysis (705), and terminate (708) operations. Although the sequence 800 may be implemented in a broader context still, the following description is made in the specific environment of FIGS. 1-2 for ease of explanation.

In step 802, the CBBA manager 102 receives notification of a role change request, and namely, a user request to modify an existing role or to add a new role to one of the records 104b-108b, change authorization data, add or change profiles, etc. More specifically, this occurs as follows. First, a user operates an interface (such as 124) to submit a request to change or add a role. For example, a manager, supervisor, or other role approver may operate the user interface 124 to submit a request to the CBBA subsystem 104, in order to add a role for a new hire, or to associate a new person with an existing role. The RTA 104a, while continuously using the sense module 210 (FIG. 2) to sense (step 610, FIG. 6) certain activity in the CBBA subsystem 104, detects the role change request. Responsive to the sensed role request, the programming 202 directs the module 213 to report (step 613, FIG. 6) the role change request to the CBBA manager 102. The CBBA manager 102 receives this report in step 802. Advantageously, the CBBA manager 102 receives notice of the role change request in real-time because it is reported by the RTA 104a, which is embedded into the software of the CBBA subsystem 104.

The sequence 800 is restarted at 802 whenever the CBBA manager 102 receives another role request, and therefore runs continuously.

In step 803, the CBBA manager 102 directs the RTA 104a to obtain all applicable information from the subsystem 104, in order to fully process the request. The CBBA manager 102 identifies the information by name, type, function, or other high level designation. In response, the programming 202 invokes the do module 212 to cross-reference the requested information against the map 220, to determine where this information is actually stored in the subsystem 104. Then, the programming 202 invokes the gather module 211 to retrieve the information so identified. With this information in-hand, the programming 202 invokes the report module 213 to send the gathered information to the manager 102.

In step 804, the CBBA manager 102 applies the risk framework 114 to the information gathered in step 803, in order to evaluate whether the role request violates the risk framework 114. This operation is performed according to step 705 as discussed above.

In step 805, the CBBA manager 102 determines the appropriate action to take based upon the results of step 804. If step 804 did not find any risk posed by the requested role change, step 805 proceeds via 805a to step 806. In step 806, the CBBA manager 102 instructs the RTA 104a to permit, carry out, or cooperate in implementing the requested change to the roles 104b.

In contrast, if step 804 found a risk violation, then the manager 102 performs one of the following steps based upon the configuration settings 122: (1) allow the role change request and notify someone (807), or (2) terminate the role change request (808). The choice between paths 805b and 805c is determined by the default or user-selected settings in the configuration 122. In one example, these settings may prescribe a choice to always select one or the other of paths 805b-805c. In another example, the settings 122 may prescribe a manner of choosing between paths 805b-805c based upon the nature of the risk, type of violation, or other conditions or context.

If path 805b is chosen, the CBBA manager 102 allows the requested role change in step 807. Namely, the CBBA manager 102 instructs the RTA 104a to permit updating of the roles 104b as requested. The programming 212 therefore refrains from invoking the do module 212 to block the requested role change, which would occur if path 805c were chosen. Despite allowing the role change, the CBBA manager 102 takes additional action by identifying and then notifying an appropriate individual appropriate to the role, role change requestor, related business unit, IT system, etc. The notification may be sent to a manager, IT administrator, supervisor, risk management personnel, etc. The report of step 807 may, for instance, contain a listing of all risk that were violated, such as the applicable listings from 114a or 114c; moreover, in preparing this report, the manager 102 may command the relevant RTAs 104-108 to gather additional, required information from the subsystems.

Also in step 807, the CBBA manager 102 may take further action, such as requiring the user (who requested the role change) to enter comments into a log, transaction history, or other audit trail correlated with the role change. Alternatively, step 807 may command the RTA 104a to automatically create or update such a log.

In contrast to steps 805b/807, the CBBA manager 102 in step 808 prevents the requested role change from occurring. Namely, the CBBA manager 102 instructs the RTA 104a to block updating of the roles 104b. In one example, the RTA 104a carries this out by invoking the do module 212. More particularly, this may be carried out by utilizing exits and standard entry points into the native system of 104, or by taking control over the entire native system and stopping, aborting, or truncating the role change process completely. In the context of an SAP subsystem 104, the RTA 104a prevents transactions such as SU01, SU10, and PFCG from executing.

In another example, step 808 may involve the CBBA manager 102 preventing an administrator from entering an exception to business rules of risky combinations or sensitive access attributes. In another example, step 808 may stop a proposed assignment of a role to a given user in one subsystem 104-108 where that role, considered with the existing assignment of another role to the same user in another subsystem, would create a segregation of duties violation.

Optionally, in step 808 the CBBA manager 102 may take the additional step of transmitting notification of the proposed but failed role change to an appropriate destination as described above. As a further option, following a prevented role change (step 808), the CBBA manager 102 may lead the user into a remediation operation 810. Remediation is discussed in greater detail above (e.g., ref. 704, FIG. 7).

### Option: Early Analysis

As an alternative to step 802 as described above, this step 802 may act before the user ultimately submits a role change request. For instance, the RTA 104a may act to sense whenever transactions are being added to roles and notify the CBBA manager 102 (step 802) even before authorization objects are defined.

In this case, the CBBA manager 102 analyzes (804) the incomplete role as it is being constructed by the user, and alerts the user (not shown) to potential violations, giving the option to continue onto authorization object definition or not. This provides the user with an option to discard the changes so far, before they spend a lot of time on a role change will ultimately fail.

### Alternative Implementation

As an alternative or additional implementation of the risk terminator features, the CBBA manager 102 may sense and terminate activities other than changes roles and assignments. For example, the CBBA manager 102 may treat circumstances where a user requests to modify a task that s/he is permitted to perform by his/her roles and assignments, or the user requests to perform one or more tasks that violate the guidelines, or the user requests to perform tasks outside the users' existing roles. Here, the RTAs 104a-108a provide substantially real time notification of users' requests to perform tasks in the CBBA subsystem. And, responsive to the notifications, the CBBA manager 102 employs the risk framework to determine whether requested the tasks have potential to violate the guidelines, and/or the requested tasks are outside the requesting users' roles 104b-108b. If either of these is true, the CBBA manager 102 directs the appropriate one or more RTAs 104a-108a to act in substantially real time to prevent the CBBA subsystem from carrying out the tasks. Or, the CBBA manager 102 allows the affected CBBA subsystems to carry out the tasks and transmits substantially real time notification of the tasks to a supervisor or other designee.

### Automated Rule Building

As mentioned above, one aspect of the system 100 involves local CBBA subsystems (such as 104-108) capable of performing various user tasks (104c-108c), yet regulating user performance of these operations according to defined roles and assignments (104b-108b). Also as mentioned above, another aspect of the system 100 involves central components (102) monitoring and carefully regulating, supporting, and augmenting changes to the roles and assignments. In carrying out this aspect, the risk framework 114 is used to determine whether or not role/assignment changes are permitted or not.

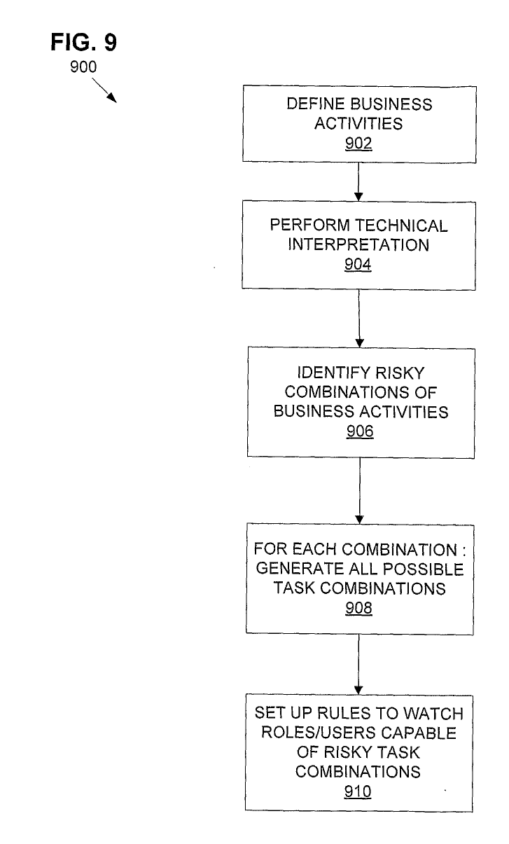

With this context in mind, a further aspect of the system 100 involves a process of constructing the risk framework 114. This process may be used for initially generating the risk framework 114 as well as revising, expanding, or updating the risk framework 114. The sequence 900 (FIG. 9) illustrates an example of this process. For explanatory purposes, the sequence 900 is discussed in the context of the system 100. The sequence 900 is nevertheless applicable in a number of different implementation settings without limitation.

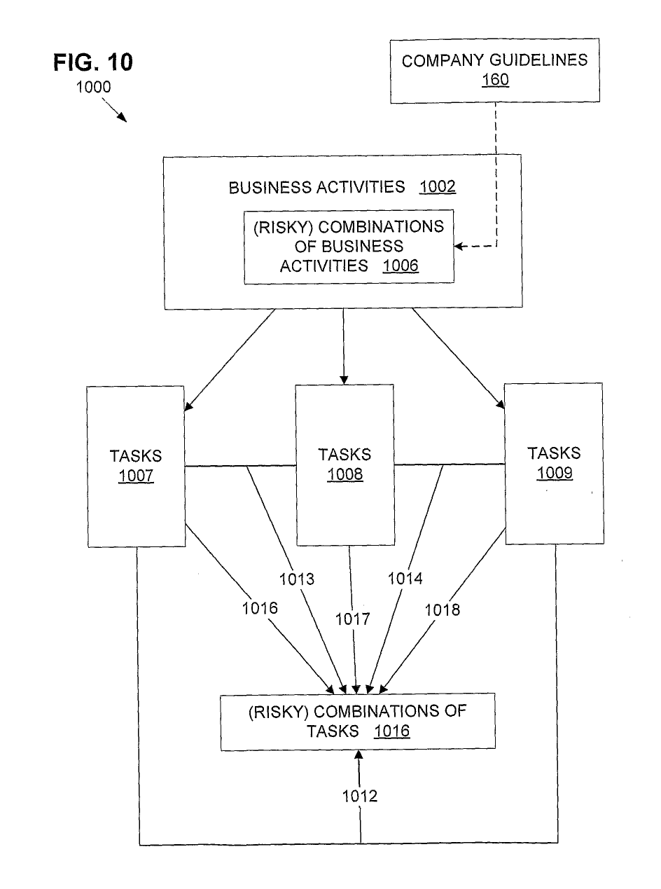

To aid in discussing the sequence 900, FIG. 10 illustrates the relationship between company guidelines 160, business activities, and CBBA subsystem-specific tasks. To start, FIG. 10 includes a depiction of the company guidelines 160 from FIG. 1. A library, collection, assortment, menu, or other selection of business activities is shown by 1002. Broadly, business activities refer to high level business operations that are capable of being carried out by the specific tasks 104c-108c of the CBBA subsystems 104-108. Table 2, below, shows some examples of business activities.

TABLE 2
BUSINESS ACTIVITIES
(some examples of 1002)

pay vendor
create vendor
pay invoice
change purchase order
make delivery
receive goods
. . .

A subset of the business activities 1002 is shown by 1006, which represents risky combinations of business activities. In particular, the activities 1006 prescribe various combinations of two or more business activities that present risk if entrusted to the same person. The “risk,” more specifically, refers to the presence of a potential for violating the prescribed company guidelines 160. Table 3 (below) illustrates some examples of the risky combinations 1006, and why these combinations are risky (“possible violation . . . ”). In one example, the possible violations provide an exemplary set of generic risks in fulfillment of 114a (FIG. 1).

TABLE 3

| RISKY | POSSIBLE VIOLATION OF COMPANY |
|---|---|
| COMBINATION OF | POLICIES, if these activities can be |
| BUSINESS ACTIVITIES | performed by the same person |
| (examples of 1006) | (examples of 114a) |
| Pay Vendor + | Pay for goods or services not received |
| Receive Goods | |
| Maintain GL Master | Create a fictitious GL account and generate |
| Records + Post | journal activity or hide activity via posting |
| Journal Entry | entries. |
| Maintain Cost Center + | Alter a cost center without authorization and |
| Cost Transfer Processing | process unauthorized cost transfers to this |
| | center, possibly distorting CO reporting. |
| Maintain Cost Center + | Alter a cost center without authorization and |
| Revenue Reposting | process unauthorized revenue entries to this |
| | center, possibly distorting CO reporting. |
| Maintain CC or CE | Manipulate cost center reports to hide |
| Groups + Post | inappropriate journal entry posting. |
| Journal Entry | |
| . . . | . . . |

Table 3 provides an abbreviated listing of risky combinations of business activities and which company policies could be violated thereby. A more exhaustive example is provided in Appendix-1 following this description. As illustrated by Appendix-1, different company policy violations may be assigned different levels of risk, such as low, medium, and high. These ratings may be based upon objective factors such as the severity of the risk to the entity if exploited, or other standards regardless of individual personal opinions. These ratings may be set by default, or by the business owner, or a combination of both. Some exemplary risk levels include:
High—Physical or monetary loss or system wide disruption can result, such as fraud, system failure, asset loss, etc.
Medium—Data integrity or manipulation or multiple system disruption can occur, with some examples including overwriting master data, bypassing business approvals, disrupting multiple business process areas, etc.
Low—Productivity losses or system failures affecting a single unit or operation can result, with some examples including misstatement of internal project costs or system outage for one plant or location.

The tasks 1007-1009 represent the entire realm of CBBA subsystem specific tasks that could possibly be invoked in carrying out the business activities 1002. In the present example, the tasks 1007-1009 correspond to machine-executable tasks 104c-108c (respectively) that can be carried out by the subsystems 104-108. Broadly, these tasks 1007-1009 include transactions (in an SAP subsystem), functions (in an ORACLE subsystem), components (in a PEOPLESOFT subsystem), or other tasks appropriate to the subsystems in use. “Tasks” 1007-1009 may be defined, however, with differing degrees of granularity. For example, in the case of a CBBA subsystem using SAP, a “task” may be (1) an action, or (2) an action plus a permission such as update, create, display, etc., or (3) an action plus a permission plus one or more further items of further detail such as documents, fields, etc.

Since the high level notion of “business activities” 1002 only has tangible meaning in the subsystems 104-108 insofar as the subsystems can perform the detailed tasks 1007-1009, a subset of the tasks 1007-1009 therefore corresponds to the risky subset 1006 of business activities. The risky task combinations are shown by 1016. These risky task combinations 1016 may arise from various intra-subsystem task combinations (as illustrated by 1016-1018), as well as inter-subsystem task combinations (as illustrated by 1012-1014). In one example, the risky task combinations 1016 provide an exemplary set of local manifestations in fulfillment of 114c (FIG. 1).

Referring to FIG. 9 (along with FIG. 10), the routine 900 shows an exemplary sequence for constructing the risk framework 114. In step 902, business activities 1002 are defined. In one example, this involves determining which business activities the CBBA subsystems 104-108 are capable of carrying out. In one case, step 902 may be carried out upon reflection of an operational CBBA subsystem. In another case, step 902 may be performed in the initial stages when designing a CBBA subsystem from scratch. In either case, step 902 is performed manually, and more particularly, by a programmer, system administrator, designer, software architect, or other appropriate person. In one example, a user operates the interface 129 (for example a GUI feature) to enter the business activities 1002 to the CBBA manager 102.

Step 904 provides a technical interpretation of the business activities 1002, including the possible ways in which each business activity may be carried out in each CBBA subsystem. More specifically, for each CBBA subsystem, step 904 lists all CBBA-subsystem specific machine-implemented tasks 1007-1009 capable of carrying out the business activities. There may be numerous different ways to carry out a given business activity, each of which is considered. Step 904 is carried out manually, and more particularly, by a programmer, system administrator, designer, software architect, or other appropriate person. In one example, a user operates the interface 129 (for example a GUI feature) to enter the tasks 1007-1009 and to correlate each business activity 1002 with its corresponding tasks 1007-1009.

As mentioned above (FIG. 10, 1007-1009), “tasks” may be defined with differing degrees of granularity. For example, in the case of a CBBA subsystem using SAP, a “task” may be (1) an action, or (2) an action plus a permission such as update, create, display, etc., or (3) an action plus a permission plus one or more further items of further detail such as documents, fields, etc. Step 904 operates differently, then, depending upon the task granularity with which the system 100 has been setup. Therefore, in performing step 904's technical interpretation, each business activity is broken down as needed to reach the full granularity. For instance, if a “task” merely corresponds to an SAP action, then, step 904 breaks each business activity down into tasks, and further specifies the relevant permissions, documents, and fields. If a “task” represents to an SAP action plus permission plus document and field, then step 904 breaks each business activity down into tasks.

Step 906 identifies combinations 1006 of business activities 1002 that are risky. Namely, step 906 identifies combinations of business activities that, if all were to be entrusted to the same person, that person would have the capability of using the system 100 in a manner that violates the company guidelines 160. If a single person were capable of carrying out these business activities, for example, that person would be capable of achieving a violation according to Table 3, and therefore capable of violating the prescribed segregation of duties rules. Step 906 is carried out manually, and more particularly, by a programmer, system administrator, designer, software architect, or other appropriate person. For example, a user may complete step 906 by operating a GUI feature of the interface 129 to communicate with the CBBA manager 102 and identify various combinations of business activities submitted in step 902.

After step 906, step 908 executes. For each identified risky combination (1006) of business activities (from 906), step 908 performs computer-driven operations of utilizing these combinations' technical interpretations (from 904) to generate all possible combinations of CBBA subsystem-specific tasks capable of carrying out the risky combination. In other words, step 908 uses the results of steps 904 and 906 to map the risky business activities 1006 into all of the various ways that these may occur in the CBBA subsystems 104-108. The result is a listing 1016 of risky combinations of CBBA subsystem tasks. Step 908 considers the possibility that each risky business activity 1006 may occur within a given CBBA subsystem (e.g., 1016-1018), as well as the possibility that risk business activity 1006 may occur across multiple CBBA subsystems (e.g., 1012-1014). In a specific example, one function of step 908 may be to assign appropriate functional level codes or authorization objects with suggested values.

Unlike steps 902-906, step 908 is computer executed. In the present example, step 908 is performed by the CBBA manager 102. The resulting task listing 1016 may be enormous. For example, with nearly two hundred risks 1006, there may be close to twenty-thousand resultant transaction combinations 1016 in some systems.

After step 908, step 910 implements machine-enforced rules regulating user activity in the CBBA subsystem, these rules proscribing occurrence of any given role or user capable of performing any of the generated combinations of tasks. In one example, step 910 is carried out by updating the risk framework 114 to reflect the results of task 906, and more particularly, by storing the task combinations 1016 in the local manifestations 114c. In single CBBA subsystem example (not shown), step 910 may be carried out by programming the local CBBA subsystem, and more particularly, by updating a risk framework 114 local to that subsystem. This enables the subsystem to regulate user activity in the CBBA subsystem, proscribing occurrence of any given role or user capable of performing any of the generated combinations of tasks.

As to rules proscribing occurrence of any given role or user capable of performing any of the generated combinations of tasks, this may involve preventing such occurrences, causing notification of such occurrences, or both. Additional detail of this feature is described above in the context of the risk terminator function (ref. 708, FIG. 7 and ref. 800, FIG. 8).

### Physical Provisioning

The examples above described various embodiments of CBBA subsystems 104-108, such as ERP subsystems, systems for compliance with government regulations, legacy data repositories, etc.

As a further example, another embodiment of CBBA subsystem includes data, processes, computing hardware, electronics, devices, or actions relating to building security or so-called “physical provisioning.” In this embodiment, one or more CBBA subsystems 104-108 include various remotely operated facility security components such as door locks, alarm systems, access zones, controllers, boom gates, elevators, readers (card, biometric, RFID etc), Positive ID Readers (PIRs) and the events and alarms that are generated by these components. This can also include other devices such as photocopiers, POS systems, HVAC systems and components, transportation access (charge) points, and other such systems that can be incorporated on smart card or other physical access technology.

In the physical provisioning context, the tasks (e.g., 104c) include acts of opening the door locks, deactivating the alarm systems, obtaining access to physical areas, operating equipment, and the like. In processing the tasks 104c-108c, the CBBA subsystem receives and evaluates individual user authentication from interfaces such as 124, 126, 128. User authentication may utilize keypad passcode, biometric identification (e.g., fingerprint, iris/retina scan), user name and password submittal, presentation of magnetic stripe card, proximity card, smart card, use of a radio frequency identification (RFID), etc. The CBBA subsystem considers information such as the user's role, assignment, and other characteristics (e.g., 104b) to determine whether to perform the requested task on behalf of the user. Insofar as the building security aspect, the CBBA subsystem may employ technology such as the commercially available products of CARDAX, GE, Honeywell, or others.

In the physical provisioning context, the management of roles (e.g., ref. 704, FIG. 7) pertains to the granting and revoking access to physical areas, machinery, and the like. Similar to the roles (e.g., 104b) as discussed above, then, the physical provisioning roles are designed to prevent segregation of duties violations. For instance, risk is likely posed by a situation where the same person has access to both a chemicals storage area (ammonium nitrate for example) as well as access to the tarmac area of an airport at a connected facility. With the addition of the physical aspect, the CBBA manager 102 can also regulate roles to prevent segregation of duties violations across the physical and logical landscapes simultaneously. For instance, risk is likely to be posed by a situation where a person has access to a physical inventory storage area according to one role, while at the same time belonging to a role which allows them to perform inventory write-offs in an ERP subsystem. The physical aspect will also deliver data to the CBBA subsystem to allow it to reference rules about whether or not a person has been physically at a site for too long in one continuous time span; or if a person has not had sufficient time away from a work site between physical visits; or where a person has exceeded certain regulatory exposure limits to toxic or radioactive substances for example.

### Other Embodiments

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the present invention, and the scope of the present invention fully encompasses other embodiments which may become obvious to those skilled in the art, and that the scope of the present invention is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC 112, sixth paragraph, unless the element is expressly recited using the phrase “means for” or, in the case of a method claim, the phrase “step for.”

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

APPENDIX 1

| BUSINESS | BUSINESS | BUSINESS | DESCRIPTION OF | |
|---|---|---|---|---|
| ACTIVITY #1 | ACTIVITY #2 | ACTIVITY #3 | VIOLATION | RISK LEVEL |
| Maintain GL Master | Post Journal | | Create a fictitious GL account | Medium |
| Records | Entry | | and generate journal activity | |
| | | | or hide activity via posting | |
| | | | entries. | |
| Maintain Cost | Cost Transfer | | Alter a cost center without | Medium |
| Center | Processing | | authorization and process | |
| | | | unauthorized cost transfers to | |
| | | | this center, possibly distorting | |
| | | | CO reporting. | |
| Maintain Cost | Revenue | | Alter a cost center without | Medium |
| Center | Reposting | | authorization and process | |
| | | | unauthorized revenue entries | |
| | | | to this center, possibly | |
| | | | distorting CO reporting. | |
| Maintain CC or CE | Post Journal | | Manipulate cost center | Medium |
| Groups | Entry | | reports to hide inappropriate | |
| | | | journal entry posting. | |
| Maintain Bank | AP Payments | | Create a non bona-fide bank | High |
| Master Data | | | account and create a check | |
| | | | from it. | |
| Maintain Asset | Process Vendor | | Pay an invoice and hide it in | Medium |
| Document | Invoices | | an asset that would be | |
| | | | depreciated over time. | |
| Maintain Asset | Goods Receipt | | Create an invoice through | Medium |
| Document | on PO | | ERS goods receipt and hide it | |
| | | | in an asset that would be | |
| | | | depreciated over time. | |
| Cash Application | Bank | | Allows differences between | High |
| | Reconciliation | | cash deposited and cash | |
| | | | collections posted to be | |
| | | | covered up | |
| Maintain Cost | Execute Cost | | Allocate costs to unauthorized | Medium |
| Center Distributions | Center | | cost centers thereby distorting | |
| | Distribution | | financial reporting. | |
| | Posting | | | |
| Maintain Internal | Internal Order | | Settle expenses from an | Medium |
| CO Order | Settlement | | unauthorized order and distort | |
| | | | CO reporting. | |
| Maintain Activity | Activity Allocation | | Alter an activity type used for | Medium |
| Types | | | cost allocation purposes with | |
| | | | fictitious data, thereby | |
| | | | distorting the cost allocation | |
| | | | process. | |
| Maintain Asset | Maintain Asset | | User responsible for asset | Medium |
| Master | Document | | masters records could | |
| | | | process transactions that | |
| | | | would allow the asset to be | |
| | | | depreciated over time. | |
| Maintain Asset | Goods Receipt | | Create the asset and | High |
| Master | on PO | | manipulate the receipt of the | |
| | | | associated asset. | |
| Process Overhead | Settle Projects | | Post overhead expenses to | Medium |
| Postings | | | the project and settle the | |
| | | | project without going through | |
| | | | the settlement approval | |
| | | | process. | |
| Maintain Projects & | Settle Projects | | Use a fictitious project to | Medium |
| WBS Elements | | | allocate overages of an actual | |
| | | | project, and settle the project | |
| | | | without going through the | |
| | | | settlement approval process. | |
| Maintain Projects & | Process | | Manipulate the work | Medium |
| WBS Elements | Overhead | | breakdown structure elements | |
| | Postings | | (profit centers, business | |
| | | | areas, cost centers, plants) | |
| | | | and post overhead expenses | |
| | | | to the project | |
| Maintain Bank | Cash Application | | Maintain a non bona-fide | High |
| Master Data | | | bank account and divert | |
| | | | incoming payments to it. | |
| Maintain Posting | Post Journal | | Open previously closed | Medium |
| Period | Entry | | accounting periods and | |
| | | | inappropriately post entries | |
| | | | after month end. | |
| Maintain Posting | AP Payments | | Open previously closed | Medium |
| Period | | | accounting periods and | |
| | | | inappropriately post payments | |
| | | | after month end. | |
| Maintain Posting | Cash Application | | User able to open accounting | Medium |
| Period | | | periods previously closed and | |
| | | | enter incoming payments | |
| | | | after month end reporting. | |
| Maintain Posting | Goods | | Open previously closed | Medium |
| Period | Movements | | accounting periods and | |
| | | | inappropriately receive or | |
| | | | issue goods after month end. | |
| Maintain GL Master | Post Tax/ | | Create a fictitious GL account | Medium |
| Records | Currency related | | and generate miscellaneous | |
| | Journal Entry | | general ledger activity or hide | |
| | | | fraudulent activity via posting | |
| | | | entries. | |
| Maintain CC or CE | Post Tax/ | | Manipulate cost center | Medium |
| Groups | Currency related | | reports to hide inappropriate | |
| | Journal Entry | | miscellaneous journal entry | |
| | | | postings. | |
| Maintain Posting | Post Tax/ | | Open previously closed | Medium |
| Period | Currency related | | accounting periods and | |
| | Journal Entry | | inappropriately post tax and | |
| | | | currency journal entries after | |
| | | | month end. | |
| Maintain Bank | Manual Check | | Create a non bona-fide bank | High |
| Master Data | Processing | | account and create a check | |
| | | | from it. | |
| Maintain Posting | Manual Check | | Open previously closed | Medium |
| Period | Processing | | accounting periods and | |
| | | | inappropriately post payments | |
| | | | after month end. | |
| Maintain a Treasury | Confirm a | | Users can create a fictitious | High |
| Item | Treasury Trade | | trade and fraudulently confirm | |
| | | | or exercise the trade | |
| Production Order | Product Costing | | Increase Production to reduce | Low |
| Processing | | | cost variances | |
| Production Order | Confirm | | Production order processing | Low |
| Processing | Production Order | | and confirming production | |
| | | | orders | |
| Confirm Production | Product Costing | | Increase Production to reduce | Low |
| Order | | | cost variances due to | |
| | | | productivity | |
| Quality Results | Delivery | | Transfer stock to general | Low |
| Reporting | Processing | | release to meet delivery | |
| | | | schedules | |
| Quality Results | Enter Counts - | Clear | Remove inferior materials by | Medium |
| Reporting | WM | Differences - | adjusting out via WM | |
| | | WM | inventory | |
| Goods Movements | Enter Counts - | Clear | Accept goods via goods | High |
| | WM | Differences - | receipts and perform a WM | |
| | | WM | physical inventory adjustment | |
| | | | afterwards. | |
| Quality Results | Confirm | | Release produced materials | Low |
| Reporting | Production Order | | to GR stock to maintain | |
| | | | production quotas | |
| Post Journal Entry | Enter Counts - | Clear | Hide WM inventory | Medium |
| | WM | Differences - | adjustments via ledger entries | |
| | | WM | | |
| Quality Results | Enter Counts - | Clear | Remove inferior materials by | Medium |
| Reporting | IM | Differences - | adjusting out via IM | |
| | | IM | inventories | |
| Quality Results | Enter Counts & | | Remove inferior materials by | Medium |
| Reporting | Clear Diff - IM | | adjusting out via IM | |
| | | | inventories | |
| Goods Movements | Enter Counts - | Clear | Accept goods via goods | High |
| | IM | Differences - | receipts and perform an IM | |
| | | IM | physical inventory adjustment | |
| | | | afterwards. | |
| Goods Movements | Enter Counts & | | Accept goods via goods | High |
| | Clear Diff - IM | | receipts and perform an IM | |
| | | | physical inventory adjustment | |
| | | | afterwards. | |
| Post Journal Entry | Enter Counts & | | Hide IM inventory | Medium |
| | Clear Diff - IM | | adjustments via ledger entries | |
| Post Journal Entry | Enter Counts - | Clear | Hide IM inventory | Medium |
| | IM | Differences - | adjustments via ledger entries | |
| | | IM | | |
| Vendor Master | Process Vendor | | Maintain a fictitious vendor | High |
| Maintenance | Invoices | | and enter a vendor invoice for | |
| | | | automatic payment | |
| AP Payments | Vendor Master | | Maintain a fictitious vendor | High |
| | Maintenance | | and create a payment to that | |
| | | | vendor | |
| Process Vendor | AP Payments | | Enter fictitious vendor | High |
| Invoices | | | invoices and then render | |
| | | | payment to the vendor | |
| Maintain Purchase | Process Vendor | | Purchase unauthorized items | High |
| Order | Invoices | | initiate payment by | |
| | | | invoicing | |
| Maintain Purchase | Goods Receipt | | Enter fictitious purchase | High |
| Order | on PO | | orders for personal use and | |
| | | | accept the goods through | |
| | | | goods receipt | |
| Process Vendor | Goods Receipt | | Enter fictitious vendor | High |
| Invoices | on PO | | invoices and accept the | |
| | | | goods via goods receipt | |
| Maintain Purchase | AP Payments | | Enter a fictitious purchase | High |
| Order | | | order and enter the covering | |
| | | | payment | |
| Vendor Master | Maintain | | Create a fictitious vendor and | High |
| Maintenance | Purchase Order | | initiate purchases to that | |
| | | | vendor | |
| Release Blocked | Service | | Receive or accept services | Medium |
| Invoices | Acceptance | | and release a previously | |
| | | | blocked Invoice to offset the | |
| | | | receipt | |
| Release Blocked | Maintain | | Enter unauthorized purchase | Medium |
| Invoices | Purchase Order | | order and release a | |
| | | | previously blocked Invoice to | |
| | | | offset the purchase order | |
| Maintain Purchase | Enter Counts & | | Inappropriately procure an | High |
| Order | Clear Diff - IM | | item and manipulate the IM | |
| | | | physical inventory counts to | |
| | | | hide. | |
| Service Master | Requisitioning | | Modify or add to service | Medium |
| Maintenance | | | master data (to add item that | |
| | | | normally is not ordered by the | |
| | | | company) and then create/ | |
| | | | change a requisition. | |
| Material Master | Maintain | | Add items to the material | Medium |
| Maintenance | Purchase Order | | master file and create | |
| | | | fraudulent purchase orders for | |
| | | | those items | |
| Bank Reconciliation | Process Vendor | | Inappropriately hide | High |
| | Invoices | | differences between bank | |
| | | | payments & posted AP | |
| | | | records | |
| Release Blocked | Goods Receipt | | Receive goods against a | Medium |
| Invoices | on PO | | purchase order and release a | |
| | | | previously blocked Invoice to | |
| | | | offset the receipt | |
| Service Acceptance | AP Payments | | Receive or accept services | High |
| | | | and enter the covering | |
| | | | payments | |
| Maintain Purchase | Service | | Enter fictitious purchase | Medium |
| Order | Acceptance | | orders for personal use and | |
| | | | accept the services through | |
| | | | service acceptance | |
| Material Master | Purchasing | | Add an item to the material | Medium |
| Maintenance | Agreements | | master file and then | |
| | | | fraudulently add those items | |
| | | | to purchasing agreements | |
| PO Approval | Goods Receipt | | Approve the purchase of | High |
| | on PO | | unauthorized goods and hide | |
| | | | the misuse of inventory by not | |
| | | | fully receiving the order | |
| PO Approval | AP Payments | | Commit the company to | High |
| | | | fraudulent purchases and | |
| | | | initiate payment for | |
| | | | unauthorized goods and | |
| | | | services. | |
| PO Approval | Process Vendor | | Release a non bona-fide | High |
| | Invoices | | purchase order and initiate | |
| | | | payment for the order by | |
| | | | entering invoices | |
| PO Approval | Enter Counts - | Clear | Release a non bona-fide | High |
| | IM | Differences - | purchase order and the action | |
| | | IM | remain undetected by | |
| | | | manipulating the IM physical | |
| | | | inventory counts | |
| PO Approval | Vendor Master | | Create a fictitious vendor or | High |
| | Maintenance | | change existing vendor | |
| | | | master data and approve | |
| | | | purchases to this vendor | |
| PO Approval | Material Master | | Add or modify material master | Medium |
| | Maintenance | | data and release a purchase | |
| | | | order for personal use | |
| Release Blocked | Purchasing | | Modify a purchasing | Medium |
| Invoices | Agreements | | agreement and release a | |
| | | | previously blocked invoice to | |
| | | | offset the vendor account. | |
| AP Payments | Purchasing | | Enter fictitious purchasing | High |
| | Agreements | | agreements and then render | |
| | | | payment | |
| Vendor Master | Purchasing | | Risk of entry of fictitious | High |
| Maintenance | Agreements | | purchasing agreements and | |
| | | | the entry of fictitious Vendor | |
| | | | or modification of existing | |
| | | | vendor especially account | |
| | | | data. | |
| Purchasing | Goods Receipt | | Modify purchasing | High |
| Agreements | on PO | | agreements and then receive | |
| | | | goods for fraudulent | |
| | | | purposes. | |
| Process Vendor | Purchasing | | Enter unauthorized items to a | High |
| Invoices | Agreements | | purchasing agreement and | |
| | | | create an invoice to obtain | |
| | | | those items for personal use | |
| AP Payments | Service Master | | Risk of modifying service | High |
| | Maintenance | | master data (to add a service | |
| | | | that is normally not ordered | |
| | | | by the company) and the | |
| | | | entry of covering payments | |
| Service Master | Release | | Risk of addition of services to | Medium |
| Maintenance | Requisitions | | the Service Master File | |
| | | | (services not related to | |
| | | | business purpose) and the | |
| | | | ability to create a Requisition | |
| | | | for those services. | |
| Release | Purchasing | | Risk of entering or | Medium |
| Requisitions | Agreements | | maintaining a purchasing | |
| | | | agreement and authorizing | |
| | | | the related requisition through | |
| | | | its release. | |
| Requisitioning | Maintain | | Risk of the same person | Medium |
| | Purchase Order | | requisitioning an item and | |
| | | | creating a purchase order | |
| | | | from that requisition. | |
| Maintain Purchase | Service Master | | Add items to the service | Medium |
| Order | Maintenance | | master file and create | |
| | | | fraudulent purchase orders for | |
| | | | those items | |
| Purchasing | Enter Counts & | | Risk of the same person | Medium |
| Agreements | Clear Diff-IM | | entering a purchasing | |
| | | | agreement for materials and | |
| | | | then adjusting the IM | |
| | | | inventory for those materials. | |
| Material Master | Requisitioning | | Risk of modifying or adding to | Medium |
| Maintenance | | | material master data (to add | |
| | | | material that normally is not | |
| | | | ordered by the company) and | |
| | | | then the release of a material | |
| | | | requisition. | |
| Requisitioning | Release | | Risk of the same person | Medium |
| | Requisitions | | requisitioning an item and | |
| | | | then releasing a requisition for | |
| | | | purchase, bypassing the | |
| | | | authorization process. | |
| AP Payments | Bank | | Risk of entering unauthorized | High |
| | Reconciliation | | payments and reconcile with | |
| | | | the bank through the same | |
| | | | person. | |
| Process Vendor | Manual Check | | Enter fictitious vendor | High |
| Invoices | Processing | | invoices and then render a | |
| | | | manual check or payment to | |
| | | | the vendor | |
| Maintain Purchase | Manual Check | | Enter a fictitious purchase | High |
| Order | Processing | | order and process a manual | |
| | | | check to act as the covering | |
| | | | manual check payment | |
| Service Acceptance | Manual Check | | Receive or accept services | High |
| | Processing | | and enter the covering | |
| | | | manual check payments | |
| PO Approval | Manual Check | | Commit the company to | High |
| | Processing | | fraudulent purchase contracts | |
| | | | and initiate manual check | |
| | | | payment for unauthorized | |
| | | | goods and services. | |
| Manual Check | Purchasing | | Enter fictitious purchasing | High |
| Processing | Agreements | | agreements and then render | |
| | | | a manual check payment | |
| Manual Check | Service Master | | Risk of modifying service | High |
| Processing | Maintenance | | master data (to add a service | |
| | | | that is normally not ordered | |
| | | | by the company) and the | |
| | | | entry of covering manual | |
| | | | check payments | |
| Manual Check | Bank | | Enter unauthorized manual | High |
| Processing | Reconciliation | | check payments and | |
| | | | reconcile with the bank | |
| | | | through the same person. | |
| Maintain Purchase | PO Approval | | Where release strategies are | High |
| Order | | | utilized, the same user should | |
| | | | not maintain the purchase | |
| | | | order and release or approve | |
| | | | it. | |
| Credit Management | Sales Orders, | | Enter or modify sales | High |
| | Agreements or | | documents and approve | |
| | Contracts | | customer credit limits | |
| Sales Orders, | Clear Customer | | Create sales documents and | High |
| Agreements or | Balance | | immediately clear customer's | |
| Contracts | | | obligation | |
| Sales Orders, | Customer Master | | Create a fictitious customer | High |
| Agreements or | Maintenance | | and initiate fraudulent sales | |
| Contracts | | | document | |
| Customer Master | Process | | Make an unauthorized | High |
| Maintenance | Customer | | change to the master record | |
| | Invoices | | (payment terms, tolerance | |
| | | | level) in favor of the customer | |
| | | | and enter an inappropriate | |
| | | | invoice | |
| Customer Master | Sales Rebates | | Inappropriately create or | High |
| Maintenance | | | change rebate agreements | |
| | | | and manage a customer's | |
| | | | master record in the favor of | |
| | | | the customer. Could also | |
| | | | change a customer's master | |
| | | | record to direct payment to an | |
| | | | inappropriate location. | |
| Clear Customer | Maintain Billing | | Potentially clear a customer's | High |
| Balance | Documents | | balance before and create or | |
| | | | make the same change to the | |
| | | | billing document for the same | |
| | | | customer, clearing them of | |
| | | | their obligation. | |
| Sales Orders, | Maintain Billing | | Inappropriately create or | High |
| Agreements or | Documents | | change a sales document and | |
| Contracts | | | generate a corresponding | |
| | | | billing document for it. | |
| Credit Management | Sales Rebates | | Manipulate the user's credit | High |
| | | | limit and assign generous | |
| | | | rebates to execute a marginal | |
| | | | customer's order. | |
| Sales Orders, | Cash Application | | Enter a fictitious sales | Medium |
| Agreements or | | | document and then render | |
| Contracts | | | fictitious payments. | |
| Cash Application | Maintain Billing | | Create a billing document for | High |
| | Documents | | a customer and | |
| | | | inappropriately post a | |
| | | | payment from the same | |
| | | | customer to conceal non- | |
| | | | payment. | |
| Customer Master | AR Payments | | Create a fictitious customer | High |
| Maintenance | | | and initiate payment to the | |
| | | | unauthorized customer. | |
| Process Credit | AR Payments | | Initiate an unauthorized | High |
| Memo | | | payment to the customer by | |
| | | | entering fictitious credit | |
| | | | memos. | |
| Cash Application | Sales Invoice | | Change the accounts | High |
| | Release | | receivable records to cover | |
| | | | differences with customer | |
| | | | statements. | |
| Sales Orders, | Delivery | | Cover up unauthorized | High |
| Agreements or | Processing | | shipment by creating a | |
| Contracts | | | fictitious sales documents | |
| Process Customer | Sales Pricing | | Sales price modifications for | High |
| Invoices | Maintenance | | sales invoicing. | |
| Sales Orders, | Sales Pricing | | Enter sales documents and | High |
| Agreements or | Maintenance | | lower prices for fraudulent | |
| Contracts | | | gain | |
| Credit Management | Cash Application | | Perform credit approval | High |
| | | | function and modify cash | |
| | | | received for fraudulent | |
| | | | purposes. | |
| Cash Application | Sales Rebates | | Enter a fictitious sales rebates | High |
| | | | and then render fictitious | |
| | | | payments. | |
| Cash Application | Customer Master | | Risk of the same person | High |
| | Maintenance | | entering changes to the | |
| | | | Customer Master file and | |
| | | | modifying the Cash Received | |
| | | | for the customer. | |
| Sales Orders, | Sales Order | | Risk of entering and releasing | Medium |
| Agreements or | Release | | sales documents by the same | |
| Contracts | | | person | |
| Sales Orders, | Sales Rebates | | Risk of entering sales | Medium |
| Agreements or | | | documents and giving sales | |
| Contracts | | | rebates by the same person, | |
| | | | effectively granting an indirect | |
| | | | price discount. | |
| Process Customer | Credit | | Risk of modifying and | High |
| Invoices | Management | | entering Sales Invoices and | |
| | | | approving Credit Limits by the | |
| | | | same person. | |
| Maintain Billing | Sales Pricing | | Risk of Sales Price | High |
| Documents | Maintenance | | modifications for Sales | |
| | | | invoicing. | |
| Customer Master | Clear Customer | | Maintain a customer master | High |
| Maintenance | Balance | | record and post a fraudulent | |
| | | | payment against it | |
| Customer Master | Maintain Billing | | User can create a fictitious | High |
| Maintenance | Documents | | customer and then issue | |
| | | | invoices to the customer. | |
| Cash Application | Process | | User can create/change an | High |
| | Customer | | invoice and enter/change | |
| | Invoices | | payments against the invoice. | |
| Delivery Processing | Cash Application | | User can create | High |
| | | | fictitious/incorrect delivery and | |
| | | | enter payments against these, | |
| | | | potentially misappropriating | |
| | | | goods. | |
| Sales Orders, | Process | | User able to create a | High |
| Agreements or | Customer | | fraudulent sales contract to | |
| Contracts | Invoices | | include additional goods and | |
| | | | enter an incorrect customer | |
| | | | invoice to hide the deception. | |
| Clear Customer | Process Credit | | Create a credit memo for a | High |
| Balance | Memo | | customer then clear the same | |
| | | | customer, prompting a | |
| | | | payment to the customer. | |
| Maintain Employee | Process Payroll | | Modify payroll master data | High |
| (PA) Master Data | | | and then process payroll. | |
| | | | Potential for fraudulent | |
| | | | activity. | |
| HR Benefits | Process Payroll | | Change employee HR | High |
| | | | Benefits then process payroll | |
| | | | without authorization. | |
| | | | Potential for fraudulent | |
| | | | activity. | |
| 3rd Party | Vendor Master | | Change to master data and | High |
| Remittance | Maintenance | | creating the remittance could | |
| | | | result in fraudulent payments. | |
| Maintain Time Data | Approve Time | | Change payroll master data | High |
| | | | and enter time data applied to | |
| | | | incorrect settings. | |
| Maintain Time Data | Process Payroll | | Modify time data and process | High |
| | | | payroll resulting in fraudulent | |
| | | | payments | |
| Change Payroll | Process Payroll | | Change configuration of | High |
| Configuration | | | payroll then process payroll | |
| | | | resulting in fraudulent | |
| | | | payments | |
| Maintain Employee | Change Payroll | | Change configuration of | High |
| (PA) Master Data | Configuration | | payroll then modify payroll | |
| | | | master data resulting in | |
| | | | fraudulent payments | |
| PD Structure | Maintain | | Change payroll master data | High |
| Maintenance | Employee (PA) | | and modify PD Structure | |
| | Master Data | | | |
| Maintain Time Data | Payroll | | Enter false time data and | High |
| | Maintenance | | perform payroll maintenance. | |
| Payroll | Process Payroll | | Change payroll and process | High |
| Maintenance | | | payroll without proper | |
| | | | authorization. | |
| Change Payroll | Payroll | | Change payroll configuration | High |
| Configuration | Maintenance | | and perform maintenance on | |
| | | | payroll settings. | |
| Maintain Time Data | Change Payroll | | Modify payroll configuration | High |
| | Configuration | | and enter false time data. | |
| Maintain Time Data | Modify PD | | Enter false time data and | High |
| | Structure | | maintain PD structure | |
| Maintain Employee | Maintain Time | | Users may enter false time | High |
| (PA) Master Data | Data | | data and process payroll | |
| | | | resulting in fraudulent | |
| | | | payments. | |
| Maintain Employee | Payroll | | Users may maintain | High |
| (PA) Master Data | Maintenance | | employee master data | |
| | | | including pay rates and delete | |
| | | | the payroll result | |
| Payroll Schemas | Maintain Time | | Users may enter false time | High |
| | Data | | data and perform work | |
| | | | schedule evaluations | |
| Time Evaluation | Maintain Time | | Users may enter false time | Medium |
| | Data | | data and perform time | |
| | | | evaluations | |
| Time Evaluation | Modify PD | | Perform time evaluations and | Medium |
| | Structure | | change the PD structure to | |
| | | | misroute the data for | |
| | | | approvals | |
| Time Evaluation | Payroll | | Perform time evaluations and | Medium |
| | Maintenance | | delete payroll results which | |
| | | | could disrupt the payroll | |
| | | | process | |
| Time Evaluation | Process Payroll | | Users who perform both the | Medium |
| | | | time evaluation and process | |
| | | | payroll could hide fraudulent | |
| | | | actions. | |
| Time Evaluation | Payroll Schemes | | Users who can perform both | Medium |
| | | | the time evaluations and | |
| | | | maintain payroll schemes to | |
| | | | hide fraudulent actions | |
| Basis Development | System | | A developer could modify an | Medium |
| | Administration | | existing program in | |
| | | | production, perform traces to | |
| | | | the program, and configure | |
| | | | the production environment to | |
| | | | run the program. This may | |
| | | | affect system performance, | |
| | | | data integrity, inappropriate | |
| | | | program modification, and | |
| | | | enable the execution of these | |
| | | | inappropriately modified | |
| | | | programs in production. | |
| Basis Development | Configuration | | A developer could modify an | High |
| | | | existing program in | |
| | | | production, perform traces to | |
| | | | the program and configure the | |
| | | | production environment to | |
| | | | limit monitoring of the | |
| | | | program run by increasing | |
| | | | alarm thresholds and | |
| | | | eliminating audit trails through | |
| | | | external OS commands. | |
| Basis Development | Client | | A developer could create or | Medium |
| | Administration | | modify a program in | |
| | | | production and replicate these | |
| | | | changes to other clients. This | |
| | | | bypasses the inherent | |
| | | | controls in the transport | |
| | | | process and could negatively | |
| | | | impact the DV and QA clients. | |
| Basis Development | Transport | | A developer could create or | High |
| | Administration | | modify a program in | |
| | | | production and force the | |
| | | | transport of these changes | |
| | | | after the fact to conceal | |
| | | | irregular development | |
| | | | practices. This also enables | |
| | | | the reverting back to the | |
| | | | program's original version | |
| | | | without any trace of the | |
| | | | changes made in production. | |
| Basis Utilities | System | | A developer could modify R/3 | Medium |
| | Administration | | program components (menus, | |
| | | | screen layout, messages, | |
| | | | queries) and configure the | |
| | | | production environment to | |
| | | | execute the program with | |
| | | | these changes. This may | |
| | | | affect system performance, | |
| | | | data integrity, inappropriate | |
| | | | program modification, and | |
| | | | enable the execution of these | |
| | | | inappropriately modified | |
| | | | program components in | |
| | | | production. | |
| Basis Utilities | Configuration | | A developer could modify R/3 | High |
| | | | program components (menus, | |
| | | | screen layout, messages, | |
| | | | queries) and configure the | |
| | | | production environment to | |
| | | | limit monitoring of the | |
| | | | program runs using the | |
| | | | modified program | |
| | | | components by increasing | |
| | | | alarm thresholds and | |
| | | | eliminating audit trails through | |
| | | | external OS commands. | |
| Basis Utilities | Client | | A developer could modify R/3 | Medium |
| | Administration | | program components (menus, | |
| | | | screen layout, messages, | |
| | | | queries) and replicate these | |
| | | | changes to other clients. This | |
| | | | bypasses the inherent | |
| | | | controls in the transport | |
| | | | process and could negatively | |
| | | | impact the DV and QA clients. | |
| Basis Utilities | Transport | | A developer could modify R/3 | High |
| | Administration | | program components (menus, | |
| | | | screen layout, messages, | |
| | | | queries) and force the | |
| | | | transport of these changes | |
| | | | after the fact to conceal | |
| | | | irregular development | |
| | | | practices. This also enables | |
| | | | the reverting back to the | |
| | | | program components' original | |
| | | | version without any trace of | |
| | | | the changes made in | |
| | | | production. | |
| Basis Table | System | | An individual could modify | High |
| Maintenance | Administration | | data in R/3 tables or modify | |
| | | | valid configuration values and | |
| | | | setup the production | |
| | | | environment to run R/3 | |
| | | | transactions and programs | |
| | | | using the inappropriately | |
| | | | modified data. This could | |
| | | | affect data integrity, system | |
| | | | performance, and proper | |
| | | | configuration of the | |
| | | | production environment. | |
| Basis Table | Client | | An individual could modify | High |
| Maintenance | Administration | | data in R/3 tables or change | |
| | | | valid configuration values and | |
| | | | replicate these changes to | |
| | | | other clients. This is | |
| | | | particularly sensitive if client | |
| | | | administration transactions | |
| | | | come with client-independent | |
| | | | authorization allowing the | |
| | | | developer to modify client- | |
| | | | independent tables and | |
| | | | configuration parameters. | |
| Security | Client | | An individual could | High |
| Administration | Administration | | inappropriately modify roles | |
| | | | and assignments and reflect | |
| | | | this change to the | |
| | | | production's mirror copy | |
| | | | eliminating the chance to | |
| | | | revert to the appropriate | |
| | | | setup. | |
| Security | Transport | | A security administrator could | High |
| Administration | Administration | | make inappropriate changes | |
| | | | to unauthorized security roles, | |
| | | | transport them, and assign | |
| | | | them to a fictitious user for | |
| | | | execution. | |
| Archiving | System | | An administrator could | Medium |
| | Administration | | execute archiving | |
| | | | transactions during peak end- | |
| | | | user usage and administer | |
| | | | the production system to | |
| | | | allow for maximum system | |
| | | | resources to complete the | |
| | | | archiving function, affecting | |
| | | | system performance. | |
| Archiving | Configuration | | A user could configure the | Medium |
| | | | production environment to | |
| | | | limit monitoring of the | |
| | | | inappropriate archiving runs | |
| | | | by increasing alarm | |
| | | | thresholds and eliminating | |
| | | | audit trails through external | |
| | | | OS commands. | |
| Archiving | Client | | A user could inappropriately | Medium |
| | Administration | | archive client-independent | |
| | | | data and settings and use | |
| | | | client administration functions | |
| | | | to replicate such changes to | |
| | | | other clients. | |
| Archiving | Transport | | Usually the individuals | Medium |
| | Administration | | responsible for archiving are | |
| | | | end-users who understand | |
| | | | the business processes and | |
| | | | data retention needs. Their | |
| | | | job responsibilities do not | |
| | | | require transport | |
| | | | administration transactions. | |
| | | | The reverse can be said for | |
| | | | the users responsible for | |
| | | | transport administration. | |
| Create Transport | Perform | | Can create transports, add | High |
| | Transport | | objects to the transport, and | |
| | | | move the transport: Can put | |
| | | | unauthorized object changes | |
| | | | into production, bypassing the | |
| | | | Change Control process. | |
| Maintain Number | System | | Can reset the number ranges | High |
| Ranges | Administration | | (1) and delete your log/audit | |
| | | | trail (2). | |
| Maintain User | Maintain Profiles/ | | One person controlling both | High |
| Master | Roles | | the access in the profile/role | |
| | | | and the user Ids increases the | |
| | | | risk of inappropriate access | |
| Maintain Model | Supply & | | Unauthorized maintenance of | High |
| | Demand | | planning model and version | |
| | Planning | | may adversely impact the | |
| | | | production planning data | |
| | | | stored in APO. This | |
| | | | transaction should be limited | |
| | | | to selected demand planning | |
| | | | super user or manager. | |
| Model & Version | Supply & | | Unauthorized deletion of | High |
| Management | Demand | | active planning version may | |
| | Planning | | adversely impact the | |
| | | | production planning data | |
| | | | stored in APO. This | |
| | | | transaction should be limited | |
| | | | to selected demand planning | |
| | | | super user or manager. | |
| Delete version | Supply & | | Unauthorized maintenance of | High |
| (version 000 - | Demand | | planning model and version | |
| active version) | Planning | | may adversely impact the | |
| | | | production planning data | |
| | | | stored in APO. This | |
| | | | transaction should be limited | |
| | | | to selected demand planning | |
| | | | super user or manager. | |
| Copy/Version | Supply & | | Access to master data | Medium |
| Management in DP | Demand | | maintenance may not be | |
| | Planning | | limited to authorized | |
| | | | individuals and may not be | |
| | | | segregated from incompatible | |
| | | | function. Inappropriate | |
| | | | changes to master data can | |
| | | | have adverse effect on the | |
| | | | planned and process orders, | |
| | | | and schedules. | |
| Maintain | Supply & | | Access to master data | Medium |
| Characteristic | Demand | | maintenance may not be | |
| Combination | Planning | | limited to authorized | |
| relevant to Planning | | | individuals and may not be | |
| | | | segregated from incompatible | |
| | | | function. Inappropriate | |
| | | | changes to master data can | |
| | | | have adverse effect on the | |
| | | | planned and process orders, | |
| | | | and schedules. | |
| Maintain Time | Supply & | | Access to master data | Medium |
| Buckets Profile | Dempland | | maintenance may not be | |
| | Planning | | limited to authorized | |
| | | | individuals and may not be | |
| | | | segregated from incompatible | |
| | | | function. Inappropriate | |
| | | | changes to master data can | |
| | | | have adverse effect on the | |
| | | | planned and process orders, | |
| | | | and schedules. | |
| Maintain Forecast | Supply & | | Access to maintain | Medium |
| Profile | Demand | | macros/rules should be | |
| | Planning | | controlled via change | |
| | | | management process. | |
| | | | Unsupported or incorrect | |
| | | | adjustments are made to the | |
| | | | macros/rules may result in | |
| | | | inaccurate production | |
| | | | planning and production | |
| | | | scheduling. | |
| Define Advanced | Supply & | | Access to maintain | High |
| Macros | Demand | | macros/rules should be | |
| | Planning | | controlled via change | |
| | | | management process. | |
| | | | Unsupported or incorrect | |
| | | | adjustments are made to the | |
| | | | macros/rules may result in | |
| | | | inaccurate production | |
| | | | planning and production | |
| | | | scheduling. | |
| Integrated Rule | Supply & | | Access to maintain | Medium |
| Maintenance | Demand | | macros/rules should be | |
| | Planning | | controlled via change | |
| | | | management process. | |
| | | | Unsupported or incorrect | |
| | | | adjustments are made to the | |
| | | | macros/rules may result in | |
| | | | inaccurate production | |
| | | | planning and production | |
| | | | scheduling. | |
| Maintain Transfer | Supply & | | Access to maintain Transfer | Medium |
| Profiles | Demand | | profiles - Group of settings | |
| | Planning | | that determine how demand | |
| | | | plans are transferred from | |
| | | | Demand Planning in APO to | |
| | | | Demand Management in R/3, | |
| | | | should be restricted to the | |
| | | | demand planning super user | |
| | | | or manager. | |
| Release Demand | Supply & | | Access to release Demand | Medium |
| Planning to SNP | Demand | | Planning to SNP should be | |
| | Planning | | restricted to the demand | |
| | | | planning super user or | |
| | | | manager. Unsupported or | |
| | | | incorrect adjustments are | |
| | | | made to the sales forecast | |
| | | | data may result in inaccurate | |
| | | | production planning and | |
| | | | detailed scheduling. | |
| Create Order | Supply & | | Access to make changes to | Medium |
| | Demand | | production orders in APO is | |
| | Planning | | restricted to the appropriate | |
| | | | production planning | |
| | | | personnel. | |
| Process Order | Supply & | | Access to make changes to | Medium |
| | Demand | | production orders in APO is | |
| | Planning | | restricted to the appropriate | |
| | | | production planning | |
| | | | personnel. | |
| S&DP | Supply & | | Access to maintain planning | Medium |
| Administration | Demand | | object structures and planning | |
| | Planning | | area via SDP Administration | |
| | | | (MSDP_ADMIN) should be | |
| | | | restricted in production | |
| | | | environment. Unauthorized | |
| | | | changes to these planning | |
| | | | structures may result in | |
| | | | inaccurate demand planning | |
| | | | and production planning. | |
| BW Administrator | Supply & | | Access to maintain BW | Medium |
| Workbench | Demand | | (feeder system) should be | |
| | Planning | | restricted from demand | |
| | | | planners and end-users. | |
| | | | Unauthorized changes to | |
| | | | maintain interfaces may result | |
| | | | in inaccurate data transfer. | |
| Live Cache | Supply & | | Unauthorized or erroneous | Medium |
| Monitoring | Demand | | reconfiguration of the live | |
| | Planning | | cache environment may | |
| | | | impact the data transfers | |
| | | | between APO and other | |
| | | | feeder systems. Access | |
| | | | should be restricted from | |
| | | | production planners. | |
| Generate & | Maintain | | Maintaining Opportunities | Medium |
| Process Leads | Opportunity | | (qualifying the lead) must be | |
| | | | independent of generating | |
| | | | leads. Sales/Production | |
| | | | forecast could be based on | |
| | | | the number of qualified leads. | |
| | | | In some companies, | |
| | | | commissions could be paid | |
| | | | based on the number of | |
| | | | qualified leads. | |
| Generate & | Maintain | | The creation of key Business | Medium |
| Process Leads | Business Partner | | Partner data should be | |
| | | | segregated from the | |
| | | | Marketing groups Leads & | |
| | | | Opportunity management. | |
| | | | BPs should only be created | |
| | | | after the appropriate review | |
| | | | by the Master Data group. | |
| Maintain Business | Process CRM | | A user could create a fictitious | High |
| Partner | Sales Orders | | business partner and initiate | |
| | | | fraudulent sales orders for | |
| | | | that partner. Master data | |
| | | | such as business partners | |
| | | | should not be maintained by | |
| | | | the same users who process | |
| | | | transactions using that master | |
| | | | data. | |
| Process CRM | Delivery | | A user could create a fictitious | High |
| Sales Orders | Processing | | sales order to cover up an | |
| | | | unauthorized shipment. | |
| Process CRM | CRM Billing | | Inappropriately create or | High |
| Sales Orders | | | change sales documents and | |
| | | | generate the corresponding | |
| | | | billing document in CRM. | |
| Process CRM | R/3 Billing | | Inappropriately create or | High |
| Sales Orders | | | change sales documents and | |
| | | | generate the corresponding | |
| | | | billing document in R/3. | |
| Service Order | Service | | Enter fictitious service orders | High |
| Processing | Confirmation | | for personal use and accept | |
| | | | the services through service | |
| | | | acceptance. The user could | |
| | | | prompt fraudulent payments. | |
| | | | In addition spare parts could | |
| | | | be fraudulently issued from | |
| | | | inventory as a result of the | |
| | | | confirmation. | |
| CRM Billing | Maintain | | User can create a fictitious | High |
| | Business Partner | | business partner and then | |
| | | | process billing in CRM for that | |
| | | | partner. | |
| R/3 Billing | Maintain | | User can create a fictitious | High |
| | Business Partner | | business partner and then | |
| | | | process billing in R/3 for that | |
| | | | partner. | |
| Service | CRM Billing | | Inappropriately accept or | High |
| Confirmation | | | confirm a service order and | |
| | | | generate a corresponding | |
| | | | billing document in CRM for | |
| | | | the order. | |
| Service | R/3 Billing | | Inappropriately accept or | High |
| Confirmation | | | confirm a service order and | |
| | | | generate a corresponding | |
| | | | billing document in R/3 for the | |
| | | | order. | |
| Inbound Delivery | Process Credit | | Internal user can be in | Medium |
| Processing | Memo | | collusion with a customer, | |
| | (Complaint) | | process a fictitious inbound | |
| | | | delivery (based on complaint | |
| | | | entered by the customer) and | |
| | | | process a credit memo to the | |
| | | | customer. | |
| Process Credit | CRM Billing | | User could create a fictitious | High |
| Memo (Complaint) | | | credit memo and run billing | |
| | | | due in CRM to prompt a | |
| | | | payment to a customer. The | |
| | | | customer could provide a | |
| | | | kickback to the internal user. | |
| Process Credit | R/3 Billing | | User could create a fictitious | High |
| Memo (Complaint) | | | credit memo and run billing | |
| | | | due in R/3 to prompt a | |
| | | | payment to a customer. The | |
| | | | customer could provide a | |
| | | | kickback to the internal user. | |
| Customer Invoices | Maintain Pricing | | Pricing conditions could be | High |
| | Conditions | | manipulated to provide | |
| | | | inappropriate discounts/ | |
| | | | incentives to customers which | |
| | | | will be realized in an incorrect | |
| | | | invoice. | |
| Process CRM | Maintain Pricing | | A user could enter a sales | High |
| Sales Orders | Conditions | | order in CRM and lower | |
| | | | prices via conditions for | |
| | | | fraudulent gain | |
| Maintain | Incentive | | Commission/Incentives may | High |
| Opportunity | Processing | | be paid based on the number | |
| | | | of qualified leads. | |
| | | | Inappropriately qualified leads | |
| | | | could result in fraudulent | |
| | | | commission payments. | |
| Service Order | Incentive | | Commission/Incentives may | High |
| Processing | Processing | | be paid based on the number | |
| | | | of service orders. | |
| | | | Fraudulent orders could be | |
| | | | entered to achieve higher | |
| | | | sales for commissions. | |
| Process CRM | Incentive | | Commission/Incentives may | High |
| Sales Orders | Processing | | be paid based on the number | |
| | | | of sales orders. Fraudulent | |
| | | | orders could be entered to | |
| | | | achieve higher sales reporting | |
| | | | for commissions. | |
| Product/Catalog | Process CRM | | Add items to product catalogs | Medium |
| Maintenance | Sales Orders | | and create fictitious sales | |
| | | | orders for those items | |
| SRM Vendor | SRM Invoicing | | Maintain a fictitious vendor | High |
| Master | | | and enter an invoice to be | |
| | | | included in the automatic | |
| | | | payment run | |
| SRM Purchasing | SRM Invoicing | | Purchase unauthorized items | High |
| | | | and prompt the payment by | |
| | | | invoicing | |
| SRM Purchasing | SRM Goods | | Enter fictitious orders for | High |
| | Receipt/Service | | personal use and accept the | |
| | Acceptance | | goods or services through | |
| | | | goods receipt or service | |
| | | | acceptance | |
| SRM Invoicing | SRM Goods | | Enter fictitious invoices and | High |
| | Receipt/Service | | accept goods or services via | |
| | Acceptance | | goods receipt or service | |
| | | | acceptance | |
| SRM Vendor | SRM Purchasing | | Maintain a fictitious vendor | High |
| Master | | | and initiate purchases to that | |
| | | | vendor. | |
| SRM Purchasing | R/3 WM Enter | R/3 WM | Inappropriately procure items | Medium |
| | Counts | Clear | and manipulate the WM | |
| | | Differences | physical inventory counts to | |
| | | | hide. | |
| SRM Purchasing | R/3 IM Enter | R/3 IM Clear | Inappropriately procure items | Medium |
| | Counts | Differences | and manipulate the IM | |
| | | | physical inventory counts to | |
| | | | hide. | |
| SRM Purchasing | R/3 IM Enter | | Inappropriately procure items | Medium |
| | Counts & Clear | | and manipulate the IM | |
| | Differences | | physical inventory counts to | |
| | | | hide. | |
| SRM Product | SRM Purchasing | | Add items to the catalog or | Medium |
| Maintenance | | | master file and create | |
| | | | fraudulent orders for those | |
| | | | items. | |
| R/3 Bank | SRM Invoicing | | A user can hide differences | High |
| Reconciliation | | | between bank payments and | |
| | | | posted AP records. | |
| SRM Goods | R/3 WM Enter | R/3 WM | Accept goods via SRM goods | High |
| Receipts | Counts | Clear | receipts and perform a WM | |
| | | Differences | physical inventory adjustment | |
| | | | afterwards. | |
| SRM Goods | R/3 IM Enter | R/3 IM Clear | Accept goods via SRM goods | High |
| Receipts | Counts | Differences | receipts and perform IM | |
| | | | physical inventory adjustment | |
| | | | afterwards. | |
| SRM Goods | R/3 IM Enter | | Accept goods via SRM goods | High |
| Receipts | Counts & Clear | | receipts and perform IM | |
| | Differences | | physical inventory adjustment | |
| | | | afterwards using powerful IM | |
| | | | transactions | |
| SRM Purchasing | R/3 Goods | | Enter fictitious orders for | High |
| | Receipt to PO | | personal use and access the | |
| | | | goods or services through | |
| | | | goods receipt | |
| SRM Purchasing | R/3 Service | | Enter fictitious orders for | High |
| | Acceptance | | personal use and access the | |
| | | | goods or services through | |
| | | | service acceptance | |
| Maintain Shopping | SRM Product | | Initiate purchases for fictitious | Medium |
| Cart | Maintenance | | goods by selecting those | |
| | | | goods to be included in a | |
| | | | shopping cart | |
| Maintain Shopping | SRM Vendor | | Maintain a fictitious vendor | Medium |
| Cart | Master | | and initiate purchases to that | |
| | | | vendor by selecting goods to | |
| | | | be included in a shopping cart | |
| SRM PO Approval | SRM Goods | | Approve the purchase of | High |
| | Receipt/Service | | unauthorized goods and hide | |
| | Acceptance | | the misuse of inventory by not | |
| | | | fully receiving the order in | |
| | | | SRM | |
| SRM PO Approval | R/3 Goods | | Approve the purchase of | High |
| | Receipt to PO | | unauthorized goods and hide | |
| | | | the misuse of inventory by not | |
| | | | fully receiving the order in R3 | |
| SRM Purchasing | SRM PO | | Where release strategies are | High |
| | Approval | | utilities, the same user should | |
| | | | not maintain the purchase | |
| | | | order and release or approve | |
| | | | it. | |
| SRM Vendor | SRM PO | | Create a fictitious vendor or | High |
| Master | Approval | | change existing vendor | |
| | | | master data and approve | |
| | | | purchases to this vendor | |
| Maintain | AP Payments | | AP/AR/GL master data | High |
| Consolidation | | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Process Vendor | | AP/AR/GL master data | High |
| Consolidation | Invoices | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Manual Check | | AP/AR/GL master data | High |
| Consolidation | Processing | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Cash Application | | AP/AR/GL master data | High |
| Consolidation | | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Process | | AP/AR/GL master data | High |
| Consolidation | Customer | | creation and posting functions | |
| Hierarchies | Invoices | | in conjunction with payment | |
| | | | processing, receipt of money, | |
| | | | GL account access; and the | |
| | | | ability to modify ECCS | |
| | | | hierarchy and reporting output | |
| Maintain | Maintain Cost | | AP/AR/GL master data | High |
| Consolidation | Center | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Maintain Asset | | AP/AR/GL master data | High |
| Consolidation | Document | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Maintain Asset | | AP/AR/GL master data | High |
| Consolidation | Master | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Revenue | | AP/AR/GL master data | High |
| Consolidation | Reposting | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Post Journal | | AP/AR/GL master data | High |
| Consolidation | Entry | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Maintain GL | | AP/AR/GL master data | High |
| Consolidation | Master Records | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Post Tax/ | | AP/AR/GL master data | High |
| Consolidation | Currency related | | creation and posting functions | |
| Hierarchies | Journal Entry | | in conjunction with payment | |
| | | | processing, receipt of money, | |
| | | | GL account access; and the | |
| | | | ability to modify ECCS | |
| | | | hierarchy and reporting output | |
| Maintain | Vendor Master | | AP/AR/GL master data | High |
| Consolidation | Maintenance | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |
| Maintain | Customer Master | | AP/AR/GL master data | High |
| Consolidation | Maintenance | | creation and posting functions | |
| Hierarchies | | | in conjunction with payment | |
| | | | processing, receipt of money, | |
| | | | GL account access; and the | |
| | | | ability to modify ECCS | |
| | | | hierarchy and reporting output | |

What is claimed is:

1. A computer-driven system for real-time monitoring one or more computer based business application (CBBA) subsystems operated on behalf of a client for compliance with prescribed guidelines, the system comprising:
embedded in programming of each CBBA subsystem, a real-time agent (RTA) comprising programming to perform operations including monitoring activity occurring in the CBBA subsystem, utilizing a map of client data and configuration settings local to the CBBA subsystem to gather information including client data and configuration settings from the CBBA subsystem, and transmitting reports substantially in real time of the activity and gathered information to a CBBA manager;
the CBBA manager, coupled to each RTA and programmed to perform operations comprising:
utilizing the reports to provide representative output in human readable format;
based upon the reports, analyzing the CBBA subsystems to detect conditions posing a potential to violate the prescribed guidelines.

2. The system of claim 1, where the CBBA subsystems comprise at least one of:
enterprise resource planning (ERP) software, government regulatory compliance software, physical provisioning software.

3. The system of claim 1, where the prescribed guidelines regulate activity of the client, the prescribed guidelines comprising one or more of the following:
company policies, government regulations, law, professional rules, accounting rules, a statement of good business practices, conditions imposed by contract or grant, corporate articles of incorporation or charter, a combination of some or all of the foregoing, other guidelines.

4. The system of claim 1, where each RTA comprises:
modules including a sense module, a gather module, a do module, and a report module;
condition-action programming responsive to predetermined input including conditions occurring in the host CBBA subsystem or input from the CBBA manager or both to trigger action by one or more of the modules corresponding to the predetermined input.

5. The system of claim 1, where the CBBA manager is further programmed to perform operations comprising:
responsive to receiving notification of actions proposed by users of a given CBBA subsystem, where said actions would violate the prescribed guidelines, directing the RTA of the given CBBA subsystem to prevent the actions from being carried out.

6. The system of claim 1, where the CBBA manager is further programmed to perform operations comprising:
responsive to receiving notification of actions proposed by users of a given CBBA subsystem, where said actions would violate the prescribed guidelines, performing operations comprising:
posing various machine-implemented remediation operations to the user, and executing the remediation operations upon user selection;
where the remediation operations include: (1) removing features of the proposed actions sufficient to avoid violating the guidelines, (2) permitting the actions as proposed but invalidating future performance of the proposed actions at a given time, (3) permitting the actions as proposed but automatically generating reports on status of the proposed actions.

7. The system of claim 1, where the CBBA manager is further programmed to perform operations comprising:
querying the RTA for configuration settings pertinent to known vulnerabilities in the CBBA subsystems;
outputting a compliance report indicating substantially real time status of the configuration settings.

8. The system of claim 1, where the CBBA manager is further programmed to perform operations comprising:
receiving user definition of conditions to be monitored in the CBBA subsystems, the conditions including user activity or configuration settings or both;
receiving user definition of actions to be completed when the conditions occur, the actions including one or more of the following: (1) generating reports of desired content to designated recipients, (2) logging occurrence of the conditions, (3) invoking human workflow responsive to occurrence of certain of the conditions, (4) invoking native software of the CBBA subsystems to stop or prevent specified events from occurring;
querying the RTAs for occurrence of the conditions;
responsive to occurrence of any of the conditions, performing one or more of the defined actions.

9. The system of claim 1, where the CBBA manager is further programmed to perform operations comprising:
querying the RTAs for occurrence of the pre-defined conditions including user activity or configuration settings or both, where the conditions represent known system vulnerabilities, risk prone activities, or deficiencies with undesirable severe consequences;
responsive to occurrence of any of the conditions, performing actions including one or more of the following: (1) generating reports of desired content to designated recipients, (2) logging occurrence of the conditions, (3) invoking human workflow responsive to occurrence of certain of the conditions, (4) invoking native software of the CBBA subsystems to stop or prevent specified events from occurring.

10. The system of claim 1, where the RTAs are programmed such that the operation of monitoring activity comprises monitoring the CBBA subsystem for occurrence of user activity violating the prescribed guidelines.

11. The system of claim 10, where the CBBA manager is programmed to respond to reports of occurrence of user activity violating the prescribed guidelines from one or more RTAs by performing operations comprising:
directing a human designee to conduct predetermined follow up action.

12. The system of claim 10, where the CBBA manager is programmed to respond to reports of occurrence of user activity violating the prescribed guidelines from one or more RTAs by performing at least one of the following operations:
facilitating user redefinition of a role or assignment, where roles define collections of permitted tasks and the assignments associate roles with people;
facilitating user performance of acts to mitigate the violation.

13. The system of claim 10, where the CBBA manager is programmed to respond to reports of occurrence of user activity violating the prescribed guidelines from one or more RTAs by performing operations comprising:
directing one or more RTAs to cause native software of the CBBA subsystem to stop or prevent specified events from occurring.

14. The system of claim 1, where:
the CBBA manager is further programmed to perform simulation operations including analyzing user-proposed hypotheticals to detect conditions with potential to violate the prescribed guidelines;
where the analysis includes directing the RTAs to obtain from the CBBA subsystems data relevant to conducting the simulation operations.

15. The system of claim 14, where the CBBA manager is programmed to perform simulation operations including analyzing user-proposed hypotheticals to detect conditions occurring within and across the CBBA subsystems.

16. The system of claim 1, where the CBBA manager is further programmed to perform operations comprising:
as to one or more given actions that violate the prescribed guidelines, permitting the actions to occur only upon implementation of one of the following mitigation measures: (1) directing the RTAs to work with native software of the CBBA subsystems to dishonor the given actions after a specified time period, (2) directing the RTAs to automatically gather information as to status of the given actions, and thereafter transmitting reports of information gathered by the RTAs to a designee.

17. The system of claim 1, where the CBBA manager is further programmed to perform operations comprising:
as to one or more given actions that violates the prescribed guidelines, permitting the action to occur only upon user-selection and system implementation of at least one of the following mitigation measures: (1) expiring the given actions after a time period, (2) automatically gathering information as to status of the given actions and reporting the status to a designee;
recruiting the RTA in carrying out the user-selected mitigation measures in the CBBA subsystem.

18. The system of claim 1, where:
the CBBA subsystems include specifications of roles and assignments, where roles define collections of permitted tasks and assignments associate roles with people;
the CBBA manager is further programmed to perform operations comprising:
as to a given user-proposed role representing a change or addition, where the proposed role poses posing a potential to violate the prescribed guidelines, permitting the proposal to occur only upon user-selection and system implementation of at least one of the following mitigation measures: (1) automatically expiring the proposed role after a time period, (2) throughout duration of the proposed role, repeatedly gathering information as to status of the given proposed role and reporting the status to a designee;
recruiting the RTA in carrying out the user-selected mitigation measures in the CBBA subsystem.

19. The system of claim 18, further comprising the operation of automatically triggering the user-selection of mitigation measures responsive to detecting that a given proposed role poses a potential to violate the prescribed guidelines.

20. The system of claim 1, where the CBBA manager is further programmed to perform operations comprising:
as to one or more given actions that violate the prescribed guidelines, permitting the actions to occur and taking additional protective measures including:
directing the RTAs to detect and report substantially in real time whenever a person exercises the given actions;
responsive to reporting that a person has executed the given actions, issuing an alert to a designee substantially in real time with receiving the report.

21. The system of claim 1, where:
the CBBA subsystems include specifications of roles and assignments, where roles define collections of permitted tasks and assignments associate roles with people;
the CBBA manager is further programmed to perform operations comprising, as to a given proposed role representing a change or addition posing a potential to violate the prescribed guidelines, accepting the proposed role and taking addition protective measures including:
directing the RTAs to detect and report substantially in real time whenever a person exercises abilities of the proposed role;
responsive to receiving a report that a person has exercised abilities of the proposed role, issuing an alert to a designee substantially in real time with receiving the report.

22. The system of claim 1, where:
the CBBA subsystems include specifications of roles and assignments, where roles define collections of permitted tasks and assignments associate roles with people;
the CBBA manager is further programmed to perform operations comprising, as to a given proposed role representing a change or addition posing a potential to violate the prescribed guidelines, accepting the proposed role and taking addition protective measures including:
directing the RTAs to detect and report substantially in real time whenever an incident occurs where person actually violates the prescribed guidelines;
responsive to receiving a report that a person has violated the prescribed guidelines, issuing an alert to a designee substantially in real time with receiving the report.

23. The system of claim 1, where:
the CBBA subsystems include respective specifications of roles and assignments, where roles define collections of permitted tasks and assignments associate roles with people;
the CBBA manager is further programmed to perform operations comprising, responsive to user input specifying changed conditions, directing the RTAs to identify all roles with common elements subject to modification due to the changed conditions, displaying identified roles to one or more human users, and facilitating user choice in changing the roles en masse.

24. A computer-driven system for real-time monitoring one or more computer based business application (CBBA) subsystems operated on behalf of a client for compliance with prescribed guidelines, the system comprising:
embedded in programming of each CBBA subsystem, real-time agent (RTA) means for monitoring activity occurring in the CBBA subsystem, utilizing a map of client data and configuration settings stored in the CBBA subsystem to gather prescribed data from the CBBA subsystem, and transmitting reports substantially in real time of the activity and gathered data to a CBBA manager means;
CBBA manager means, coupled to each RTA, for utilizing the reports to provide a representative output in human readable format substantially in real time, and also using the reports to analyze the CBBA subsystems to detect conditions posing a potential to violate the prescribed guidelines.

25. Computer readable storage media tangibly embodying programs of machine-readable instructions executable by digital processing equipment to perform real-time monitoring of one or more computer based business application (CBBA) subsystems operated on behalf of a client for compliance with prescribed guidelines, the programs comprising:
embedded in programming of each CBBA subsystem, a real-time agent (RTA) program performing operations comprising: monitoring activity occurring in the CBBA subsystem, utilizing a map of client data and configuration settings stored in the CBBA subsystem to gather prescribed data from the CBBA subsystem, and transmitting reports substantially in real time of the activity and gathered data to a CBBA manager program;
the CBBA manager program to perform operations including utilizing the reports to provide a representative output in human readable format substantially in real time, and based upon the reports, analyzing the CBBA subsystems to detect conditions posing a potential to violate the prescribed guidelines.

26. (canceled)

27. A computer-driven system for real-time monitoring of at least one computer based business application (CBBA) subsystem operated on behalf of a client for compliance with prescribed guidelines, where each CBBA subsystem includes a record of roles and assignments, each role including a collection of permitted tasks, the assignments associating roles with people, the system comprising:
embedded in programming of each CBBA system, a real-time agent (RTA) comprising programming to perform operations including monitoring activity in the CBBA subsystem, utilizing a map of client data and configuration settings local to the CBBA subsystem to gather data from the CBBA subsystem, and transmitting reports substantially in real time of the activity and gathered data to a CBBA manager;
a risk framework identifying different possible configurations of the roles and assignments with potential to violate the prescribed guidelines;
the CBBA manager, coupled to each RTA and the risk framework, and programmed to perform operations comprising:
recruiting the RTAs to provide substantially real time notification of users proposals for modifying the record of roles and assignments;
responsive to notifications of such proposals, employing the risk framework to determine whether the proposals have potential to violate the prescribed guidelines, and if so, performing at least one of the following:
directing one or more RTAs to act in substantially real time to prevent the CBBA subsystems from carrying out the proposals;
allowing the CBBA subsystems to carry out the proposals, and transmitting substantially real time notification of one of the following to a designee: (1) the proposals, (2) activity carried out by one or more users with authority provided by roles and assignments changed by the proposal.

28. A computer-driven system for real-time monitoring of at least one computer based business application (CBBA) subsystem operated on behalf of a client for compliance with prescribed guidelines, where the CBBA subsystem includes a record of roles and assignments, each role including a collection of permitted tasks, the assignments associating roles with people, the system comprising:
embedded in programming of each CBBA system, real-time agent (RTA) means for performing operations including monitoring activity in the CBBA subsystem, utilizing a map of client data and configuration settings local to the CBBA subsystem to gather data from the CBBA subsystem, and transmitting reports substantially in real time of the activity and gathered data to a CBBA manager means;
risk framework means for identifying different possible configurations of the roles and assignments with potential to violate the prescribed guidelines;
CBBA manager means, coupled to the RTA means and the risk framework means, for performing operations including:
recruiting the RTA means to provide substantially real time notification of users' proposals for modifying the record of roles and assignments;
responsive to notifications of such proposals, employing the risk framework means to determine whether the proposals have potential to violate the prescribed guidelines, and if so, performing at least one of the following:
directing one or more of the RTA means to act in substantially real time to prevent the CBBA subsystems from carrying out the proposals;
allowing the CBBA subsystem to carry out the proposals, and transmitting substantially real time notification of one of the following to a designee: (1) the proposals, (2) activity carried out by one or more users with authority provided by roles and assignments changed by the proposal.

29. Computer readable storage media tangibly embodying programs of machine-readable instructions executable by digital processing equipment to perform real-time monitoring of at least one computer based business application (CBBA) subsystem operated on behalf of a client for compliance with prescribed guidelines, where the CBBA subsystem includes a record of roles and assignments, each role including a collection of permitted tasks, the assignments associating roles with people, the programs comprising:
embedded in programming of each CBBA system, a real-time agent (RTA) program to perform operations including monitoring activity in the CBBA subsystem, utilizing a map of client data and configuration settings local to the CBBA subsystem to gather data from the CBBA subsystem, and transmitting reports substantially in real time of the activity and gathered data to a CBBA manage program;
the CBBA manager program, coupled to each RTA program and a risk framework identifying different possible configurations of the roles and assignments with potential to violate the prescribed guidelines, to perform operations comprising:
recruiting the RTA programs to provide substantially real time notification of users' proposals for modifying the record of roles and assignments;
responsive to notifications of such proposals, employing the risk framework to determine whether the proposals have potential to violate the prescribed guidelines, and if so, performing at least one of the following:
directing one or more RTA programs to act in substantially real time to prevent the CBBA subsystems from carrying out the proposals;
allowing the CBBA subsystems to carry out the proposals, and transmitting substantially real time notification of one of the following to a designee: (1) the proposals, (2) activity carried out by one or more users with authority provided by roles and assignments changed by the proposal.

30. A computer readable storage medium tangibly embodying a program of machine-readable instructions executable by a digital processing apparatus to install target programs of machine-readable instructions on a computer, where the target programs are executable to perform real-time monitoring of one or more computer based business application (CBBA) subsystems operated on behalf of a client for compliance with prescribed guidelines, the target programs comprising:
embedded in programming of each CBBA system, a real-time agent (RTA) program to perform operations including monitoring activity in the CBBA subsystem, utilizing a map of client data and configuration settings local to the CBBA subsystem to gather data from the CBBA subsystem, and transmitting reports substantially in real time of the activity and gathered data to a CBBA manage program;
the CBBA manager program, coupled to each RTA program and a risk framework identifying different possible configurations of the roles and assignments with potential to violate the prescribed guidelines, to perform operations comprising:
recruiting the RTA programs to provide substantially real time notification of users' proposals for modifying the record of roles and assignments;
responsive to notifications of such proposals, employing the risk framework to determine whether the proposals have potential to violate the prescribed guidelines, and if so, performing at least one of the following:
directing one or more RTA programs to act in substantially real time to prevent the CBBA subsystems from carrying out the proposals;
allowing the CBBA subsystems to carry out the proposals, and transmitting substantially real time notification of one of the following to a designee: (1) the proposals, (2) activity carried out by one or more users with authority provided by roles and assignments changed by the proposal.

31. A computer-driven system for real-time monitoring of at least one computer based business application (CBBA) subsystem operated on behalf of a client for compliance with prescribed guidelines, where the CBBA subsystem includes a record of roles and assignments, each role including a collection of permitted tasks, the assignments associating roles with people, the system comprising:
embedded in programming of each CBBA system, a real-time agent (RTA) performing operations including monitoring activity in the CBBA subsystem, utilizing a map of client data and configuration settings stored in the CBBA subsystem to gather data from the CBBA subsystem, and
transmitting reports substantially in real time of the activity and gathered data to a CBBA manager;
a risk framework identifying different possible activities with potential to violate the prescribed guidelines;
the CBBA manager, coupled to each RTA and the risk framework, and programmed to perform operations comprising:
recruiting the RTAs to receive substantially real time notification of users' requests to perform tasks in the CBBA subsystem;
responsive to the notifications, employing the risk framework to determine the following conditions: (1) the requested tasks have potential to violate the guidelines, (2) the requested tasks are outside the requesting users' roles;
responsive to any of the conditions being true, performing at least one of the following risk treatment operations:
directing the RTA to act in substantially real time to prevent the CBBA subsystem from carrying out the requested tasks;
allowing the CBBA subsystem to carry out the tasks, and transmitting substantially real time notification of the tasks to a designee.

32. A computer-driven system for real-time monitoring of at least one computer based business application (CBBA) subsystem operated on behalf of a client for compliance with prescribed guidelines, where the CBBA subsystem includes a record of roles and assignments, each role including a collection of permitted tasks, the assignments associating roles with people, the system comprising:
embedded in programming of each CBBA system, real-time agent (RTA) means for performing operations including monitoring activity in the CBBA subsystem, utilizing a map of client data and configuration settings stored in the CBBA subsystem to gather data from the CBBA subsystem, and transmitting reports substantially in real time of the activity and gathered data to a CBBA manager means;
risk framework means for identifying different possible activities with potential to violate the prescribed guidelines;
CBBA manager means, coupled to each RTA and the risk framework means, for performing operations comprising:
recruiting the RTA means to receive substantially real time notification of users' requests to perform tasks in the CBBA subsystem;
responsive to the notifications, employing the risk framework means to determine the following conditions: (1) the requested tasks have potential to violate the guidelines, (2) the requested tasks are outside the requesting users' roles;
responsive to any of the conditions being true, performing at least one of the following risk treatment operations:
directing the RTA means to act in substantially real time to prevent the CBBA subsystem from carrying out the requested tasks;
allowing the CBBA subsystem to carry out the tasks, and transmitting substantially real time notification of the tasks to a designee.

33. Computer readable storage media tangibly embodying programs of machine-readable instructions executable by digital processing equipment to perform real-time monitoring of at least one computer based business application (CBBA) subsystem operated on behalf of a client for compliance with prescribed guidelines, where the CBBA subsystem includes a record of roles and assignments, each role including a collection of permitted tasks, the assignments associating roles with people, the programs comprising:
embedded in programming of each CBBA system, a real-time agent (RTA) program performing operations including monitoring activity in the CBBA subsystem, utilizing a map of client data and configuration settings stored in the CBBA subsystem to gather data from the CBBA subsystem, and transmitting reports substantially in real time of the activity and gathered data to a CBBA manager program;
CBBA manager program, coupled to each RTA and a risk framework identifying different possible activities with potential to violate the prescribed guidelines, performing operations comprising:
recruiting the RTA programs to receive substantially real time notification of users' requests to perform tasks in the CBBA subsystem;
responsive to the notifications, employing the risk framework to determine the following conditions: (1) the requested tasks have potential to violate the guidelines, (2) the requested tasks are outside the requesting users' roles;
responsive to any of the conditions being true, performing at least one of the following risk treatment operations:
directing the RTA programs to act in substantially real time to prevent the CBBA subsystem from carrying out the requested tasks;
allowing the CBBA subsystem to carry out the tasks, and transmitting substantially real time notification of the tasks to a designee.

34. A computer readable storage medium tangibly embodying a program of machine-readable instructions executable by a digital processing apparatus to install target programs of machine-readable instructions on a computer, where the target programs are executable to perform real-time monitoring of one or more computer based business application (CBBA) subsystems operated on behalf of a client for compliance with prescribed guidelines, the target programs comprising:
embedded in programming of each CBBA system, a real-time agent (RTA) program performing operations including monitoring activity in the CBBA subsystem, utilizing a map of client data and configuration settings stored in the CBBA subsystem to gather data from the CBBA subsystem, and transmitting reports substantially in real time of the activity and gathered data to a CBBA manager program;
CBBA manager program, coupled to each RTA and a risk framework identifying different possible activities with potential to violate the prescribed guidelines, performing operations comprising:
recruiting the RTA programs to receive substantially real time notification of users' requests to perform tasks in the CBBA subsystem;
responsive to the notifications, employing the risk framework to determine the following conditions: (1) the requested tasks have potential to violate the guidelines, (2) the requested tasks are outside the requesting users' roles;
responsive to any of the conditions being true, performing at least one of the following risk treatment operations:
directing the RTA programs to act in substantially real time to prevent the CBBA subsystem from carrying out the requested tasks;
allowing the CBBA subsystem to carry out the tasks, and transmitting substantially real time notification of the tasks to a designee.

35. A computer-driven system for real-time monitoring of multiple computer based business application (CBBA) subsystems operated on behalf of a client for compliance with prescribed guidelines, the system comprising:
multiple real-time agents (RTA) each embedded in programming of a different CBBA subsystem, each RTA comprising programming to perform operations including monitoring activity occurring in the CBBA subsystem, utilizing a map of client data and configuration settings local to the CBBA subsystem to gather prescribed data from the CBBA subsystem, and transmitting reports substantially in real time of the activity and gathered data to a CBBA manager;
the CBBA manager, coupled to the RTAs and programmed to perform operations comprising collecting reports of the RTAs and analyzing the collected reports to detect conditions occurring within and across the CBBA subsystems that pose a potential to violate the prescribed guidelines.

36. A computer-driven system for real-time monitoring of multiple computer based business application (CBBA) subsystems operated on behalf of a client for compliance with prescribed guidelines, the system comprising:
embedded in programming of each CBBA subsystem, real-time agent (RTA) means for monitoring activity occurring in the CBBA subsystem, utilizing a map of client data and configuration settings local to the CBBA subsystem to gather prescribed data from the CBBA subsystem, and transmitting reports substantially in real time of the activity and gathered data to a CBBA manager;
CBBA manager means, coupled to the RTA means, for collecting reports of the RTA means and analyzing the collected reports to detect conditions occurring within and across the CBBA subsystems that pose a potential to violate the prescribed guidelines.

37. Computer readable storage media tangibly embodying programs of machine-readable instructions executable by digital processing equipment to perform real-time monitoring of multiple computer based business application (CBBA) subsystems operated on behalf of a client for compliance with prescribed guidelines, the programs comprising:
embedded in programming of each CBBA subsystem, real-time agent (RTA) program monitoring activity occurring in the CBBA subsystem, utilizing a map of client data and configuration settings local to the CBBA subsystem to gather prescribed data from the CBBA subsystem, and transmitting reports substantially in real time of the activity and gathered data to a CBBA manager;
a CBBA manager program, coupled to the RTA programs, collecting reports of the RTAs and analyzing the collected reports to detect conditions
occurring within and across the CBBA subsystems that pose a potential to violate the prescribed guidelines.

38. A computer readable storage medium tangibly embodying a program of machine-readable instructions executable by a digital processing apparatus to install target programs of machine-readable instructions on a computer, where the target programs are executable to perform real-time monitoring of one or more computer based business application (CBBA) subsystems operated on behalf of a client for compliance with prescribed guidelines, the target programs comprising:
embedded in programming of each CBBA subsystem, real-time agent (RTA) program monitoring activity occurring in the CBBA subsystem, utilizing a map of client data and configuration settings local to the CBBA subsystem to gather prescribed data from the CBBA subsystem, and transmitting reports substantially in real time of the activity and gathered data to a CBBA manager program;
a CBBA manager program, coupled to the RTA programs, collecting reports of the RTAs and analyzing the collected reports to detect conditions occurring within and across the CBBA subsystems that pose a potential to violate the prescribed guidelines.

39. In a computing system that includes one or more modules of computer based business application (CBBA) software that serves an exclusive mechanism to perform various predefined tasks on request of networked users, each module also defining which of the users is permitted to perform tasks of that module, a CBBA management system comprising:
embedded in each module, an agent programmed to perform operations including:
retrieving client data and configuration settings from the module and reporting retrieved data and configuration settings to a CBBA manager substantially in real time;
preventing prescribed activity in the module;
automatically sensing activity in the module and reporting sensed activity to the CBBA manager substantially in real time;
external of the CBBA software modules, the CBBA manager programmed to perform operations comprising:
operating the agents to extract prescribed client data and configuration settings substantially in real time;
conducting predetermined risk analysis operations upon the extracted data and configuration settings and the reports of sensed activity.

40. The CBBA management system of claim 39, where the CBBA software comprises at least one of: enterprise resource planning (ERP) software, government regulatory compliance software, physical provisioning software.

41. A method for constructing a set of rules to monitor activity in one or more computer-based business applications (CBBA) subsystems, where each CBBA subsystem includes a record of roles and assignments, each role including a collection of permitted tasks, the assignments associating roles with people, the method comprising operations of:
establishing a library of business activities;
providing a technical interpretation of the business activities including how each business activity may be carried out in each CBBA subsystem, the interpretation including, for each CBBA subsystem, a listing of CBBA subsystem-specific machine-implemented tasks capable of carrying out the business activity;
establishing a risk framework identifying combinations of business activities that, if entrusted to an individual, enable that individual to violate a prescribed set of operating guidelines for an entity on whose behalf the CBBA subsystems are operated;
for each identified combination of business activities, performing computer-driven operations of utilizing the technical interpretations of the combination of business activities to generate all possible combinations of CBBA subsystem-specific tasks capable of carrying out the identified combination of business activities;
implementing machine-enforced rules regulating roles and assignments to proscribe any individual from being capable of performing any of the generated combinations of CBBA subsystem-specific tasks.

42. The method of claim 41, where the prescribed set of operating guidelines comprise one or more of the following:
company policies, government regulations, penal law, accounting rules, good business practices, conditions imposed by contract, corporate articles of incorporation or charter, or other guidelines.

43. The method of claim 41, the implementing operation comprising programming the CBBA subsystems to implement the rules.

44. The method of claim 41, the implementing operation comprising programming a CBBA manager remote from the CBBA subsystems to regulate the CBBA subsystems causing the CBBA subsystems to implement the rules.

45. The method of claim 41, the implementing operation comprising programming a CBBA manager remote from the CBBA subsystems to operate embedded code within the CBBA subsystems to cause the CBBA subsystems to implement the rules.

46. The method of claim 41, the implementing operation performed such that the rules comprise at least one of:
rules preventing any individual from being capable of performing any of the generated combinations of CBBA subsystem-specific tasks;
rules causing notification upon any individual being capable of performing any of the generated combinations of CBBA subsystem-specific tasks.

47. A method for constructing a set of rules to monitor activity in one or more computer-based business applications (CBBA) subsystems, where each CBBA subsystem includes a record of roles and assignments, each role including a collection of permitted tasks, the assignments associating roles with people, the method comprising the steps of:
a step for establishing a library of business activities;
a step for providing a technical interpretation of the business activities including how each business activity may be carried out in each CBBA subsystem, the interpretation including, for each CBBA subsystem, a listing of CBBA subsystem-specific machine-implemented tasks capable of carrying out the business activity;
a step for establishing a risk framework identifying combinations of business activities that, if entrusted to an individual, enable that individual to violate a prescribed set of operating guidelines for an entity on whose behalf the CBBA subsystems are operated;
a step for each identified combination of business activities, performing computer-driven operations of utilizing the technical interpretations of the combination of business activities to generate all possible combinations of CBBA subsystem-specific tasks capable of carrying out the identified combination of business activities;
a step for implementing machine-enforced rules regulating roles and assignments to proscribe any individual from being capable of performing any of the generated combinations of CBBA subsystem-specific tasks.

48. A method for building rules to monitor predefined business activities carried out by one or more computer-based business applications (CBBA) subsystems, comprising operations of:
for each CBBA subsystem, preparing a listing of all CBBA subsystem-specific tasks capable of carrying out each of the predefined business activities;
performing computer-driven operations including:
referencing sources including the listing and a risk framework identifying combinations of business activities that, if entrusted to an individual, enables the individual to violate a prescribed set of operating guidelines for an entity on whose behalf the CBBA subsystems are operated, and utilizing the sources to generate all combinations of CBBA subsystem-specific tasks capable of carrying out each identified combination of business activities;
providing a machine-accessible risk framework embodying the combinations of CBBA subsystem-specific tasks capable of carrying out each identified combination of business activities for use in regulating assignment of any of the generated combinations of CBBA subsystem-specific tasks to any individual or role.

49. A computer readable storage medium tangibly embodying a program of machine-readable instructions executable by a digital processing apparatus to perform operations to build rules to monitor business activities carried out by one or more computer-based business applications (CBBA) subsystems, the operations comprising:
for each CBBA subsystem, receiving access to a listing identifying all CBBA subsystem-specific tasks capable of carrying out each of the business activities;
receiving access to a risk framework identifying each combination of business activities that, if entrusted to an individual, enable the individual to violate a prescribed set of operating guidelines for an entity on whose behalf the CBBA subsystems are operated;
utilizing the listing and the risk framework as input to generate all combinations of CBBA subsystem-specific tasks capable of carrying out each identified combination of business activities;
generating a set of rules proscribing assignment of any of the generated combinations of CBBA subsystem-specific tasks to any individual or role.

50. A computer readable storage medium tangibly embodying a program of machine-readable instructions executable by a digital processing apparatus to install target programs of machine-readable instructions on a computer, where the target programs are executable to perform operations for building rules to monitor business activities carried out by one or more computer-based business applications (CBBA) subsystems, the operations comprising:
for each CBBA subsystem, receiving access to a listing identifying all CBBA subsystem-specific tasks capable of carrying out each of the business activities;
receiving access to a risk framework identifying each combination of business activities that, if entrusted to an individual, enable the individual to violate a prescribed set of operating guidelines for an entity on whose behalf the CBBA subsystems are operated;
utilizing the listing and the risk framework as input to generate all combinations of CBBA subsystem-specific tasks capable of carrying out each identified combination of business activities;
generating a set of rules proscribing assignment of any of the generated combinations of CBBA subsystem-specific tasks to any individual or role.

51. A security system, comprising:
a record of roles and assignments, each role including a collection of permitted tasks, the assignments associating roles with people;
one or more subsystems programmed to perform tasks including authenticating users and selectively providing authenticated users with access to physical facilities only if permitted by roles assigned to the user;
a manager, coupled to the subsystems and programmed to perform operations comprising:
receiving notification of users' proposed changes to the record of roles and assignments;
responsive to the notifications, analyzing the proposed changes to identify potential for a person to violate prescribed segregation of duties guidelines due to that person having concurrent abilities to access to particular physical facilities;
permitting the proposed changes only if the analyzing operation does not identify any potential to violate the prescribed segregation of duties guidelines.

52. The system of claim 51, where the physical facilities include at least one of: (1) remotely operated facility security components of a group including: door locks, alarm systems, access zones, controllers, boom gates, elevators, card readers, biometric readers, radio frequency identification (RFID) readers, positive ID readers, (2) equipment of a group including: photocopiers, point-of-sale systems, transportation access points, heating ventilation and air conditioning (HVAC) systems and components.

53. The system of claim 51, the manager further programmed to perform additional operations including:
applying prescribed criteria to peoples' ability to access physical facilities, and issuing an alert whenever the criteria are satisfied.

54. The system of claim 51, the manager further programmed to perform additional operations including:
issuing an alert whenever a person is found to have been at one site for at least a given minimum time period.

55. The system of claim 51, the manager further programmed to perform additional operations including:
issuing an alert whenever a person's time away from a given work site fails to meet a given minimum time period.

56. The system of claim 51, the manager further programmed to perform additional operations including:
issuing an alert whenever a person is found to have met a designated exposure limit to designated substances due to the person's presence in a physical space allocated for storing such substances.

57. A computer-driven system for monitoring configuration client subsystems for compliance with prescribed guidelines, where the client subsystems include (1) one or more computer based business application (CBBA) subsystems selectively carrying out user-requested business activities permitted by predefined roles and assignments, and (2) one or more security subsystems selectively providing access to physical facilities permitted by predefined roles and assignments, and where each subsystem includes a record of roles and assignment, where each role includes a collection of permitted tasks and each assignments associates one or more roles with one or more people, the system comprising:
a machine-readable risk framework;
a manager, coupled to the risk framework and the subsystems, and programmed to perform operations comprising:
receiving notification of users' proposed changes to the records of roles and assignments;
responsive to the notifications, analyzing the proposed changes against the risk framework to identify any potential for people to violate prescribed guidelines by having any of the following concurrent abilities: (1) to access multiple designated physical facilities, (2) to perform multiple designated computer-performed business processes, (3) to access one or more designated physical facilities and to perform one or more designated computer-performed business processes;
permitting the proposed changes only if the proposed changes do not present any potential violations of the prescribed guidelines.

58. The system of claim 57, where the risk framework prescribes that a person has potential to violate the prescribed guidelines if the roles and assignments provide the person with concurrent abilities to physically access an inventory storage area and to perform a computer-based business process of performing inventory write-offs.

59. A system, comprising:
one or more computer based business application (CBBA) subsystems;
a real-time agent (RTA) embedded in programming of each CBBA subsystem to gather CBBA data corresponding to each respective CBBA subsystem, and to communicate in substantially real-time the CBBA data to a CBBA manager; and
the CBBA manager to receive and process the CBBA data from each respective RTA, and to compare the CBBA data to prescribed guidelines to detect a violation of the prescribed guidelines.

60. The system of claim 59, wherein the RTA to gather the CBBA data is to cross-reference an information map to provide the RTA with a storage location of the CBBA data associated with its respective CBBA subsystem.

61. The system of claim 59, wherein the RTA to gather the CBBA data is to receive a request for the CBBA data from the CBBA manager.

62. A system, comprising:
a real-time agent (RTA) embedded in programming of each of one or more CBBA subsystems to receive a request from a CBBA manager for CBBA data, each RTA including:
a do module to determine where in the CBBA subsystem the requested CBBA data is stored;
a gather module to retrieve the requested CBBA data based on the determination of the do module; and
a report module to communicate the gathered CBBA data to the CBBA manager.

63. The system of claim 62, wherein the do module to determine where the CBBA data is stored is further to cross-reference an information map to provide the gather module with a storage location of the requested CBBA data associated with CBBA subsystem.
